(19) United States
(12) Patent Application Publication
(10) Pub. No.: US 2026/0284639 A1
(43) Pub. Date: Sep. 24, 2026

(54) SYSTEMS, METHODS, AND CATALYSTS FOR SYNGAS, CHEMICAL, AND FUEL PRODUCTION

(71) Applicant: Dimensional Energy, Inc., Ithaca, NY (US)

(72) Inventors: Bradley Brennan, Omaha, NE (US); Ali Sangghaleh, Ithaca, NY (US); Bruce Logue, Sugar Land, TX (US); Samuel Roman Garncarz, Ithaca, NY (US)

(21) Appl. No.: 19/475,687

(22) PCT Filed: Apr. 19, 2024
(86) PCT No.: PCT/US2024/025375

§ 371 Date: Oct. 15, 2025

Related U.S. Application Data
(60) Provisional application No. 63/460,340, filed on Apr. 19, 2023.

(51) Int. Cl. B01J 23/10; B01J 21/04; B01J 23/00; B01J 37/02; B01J 37/08; C01B 32/40

(52) U.S. Cl. CPC B01J 23/10; B01J 21/04; B01J 23/002; B01J 37/0201; B01J 37/0236; B01J 37/088; C01B 32/40; B01J 2523/3712; B01J 2523/3718; B01J 2523/48

(57) ABSTRACT

A catalyst includes catalytically active material including a formula: CeJQO, wherein Ce is Cerium, J includes at least one of Zirconium, Hafnium, Niobium, Tantalum, and Titanium, Q includes at least one of Praseodymium, Terbium, Thulium, Europium, Samarium, Ytterbium, Gallium, Germanium, Indium, Tin, Antimony, and Bismuth, and O is oxygen; and a support, wherein the catalyst has greater than 95% selectivity for carbon monoxide formation in a mixture of carbon dioxide and hydrogen operated at a temperature above 400° C. Catalysts, systems, and methods for syngas, chemical, and/or liquid fuel production are provided in the present disclosure.

### CROSS REFERENCE TO RELATED APPLICATION

This application claims benefit of U.S. Provisional Application No. 63/460,340, filed on Apr. 19, 2023. U.S. Provisional Application No. 63/460,340 is incorporated herein by reference. A claim of priority is made.

### STATEMENT OF GOVERNMENT RIGHTS

This invention was made with Government support under Grant (or Contract) No. IIP-1853888 through ASEE, awarded by the National Science Foundation-Innovative Postdoctoral Entrepreneurial Research Fellowship. The Government has certain rights in this invention.

### TECHNICAL FIELD

The subject matter disclosed herein relates broadly to the fields of chemical production and energy conversion, and in particular, to syngas and/or liquid fuel production.

### BACKGROUND

The utilization of carbon dioxide for producing value-added products provides a unique solution to current environmental challenges. Current environmental challenges include at least the increase in carbon dioxide emissions and atmospheric concentrations thereof. The reverse-water gas shift reaction (RWGS) is an endothermic reaction producing syngas from carbon dioxide and hydrogen. Current reverse water gas shift reactions include undesired side reactions such as methanation and coking, normally requiring high temperatures to overcome. This methanation requires downstream purification or eventual removal of methane by subsequent processing methods. Coking limits the functional lifetime of the catalyst and reactor, requiring regeneration cycles or replacement. Therefore, there is a need for a catalyst that is stable under a wide temperature range, has a high selectivity for the reverse water gas shift reaction, and reduces or prevents undesired side reaction products. Further, many current liquid fuel production processes produce conventional liquid fuels, such as gasoline and diesel fuels, by distilling petroleum oil. Not only do these conventional processes require petroleum—these processes consume large amounts of energy. There is a need for a liquid fuel production process that can efficiently convert feed stocks including carbon dioxide to liquid fuels and chemicals.

### SUMMARY

According to one aspect, a catalyst includes catalytically active material including a formula: CeJQO, wherein Ce is Cerium, J includes at least one of Zirconium, Hafnium, Niobium, Tantalum, and Titanium, Q includes at least one of Praseodymium, Terbium, Thulium, Europium, Samarium, Ytterbium, Gallium, Germanium, Indium, Tin, Antimony, and Bismuth, and O is oxygen; and a support, wherein the catalyst has greater than 95% selectivity for carbon monoxide formation in a mixture of carbon dioxide and hydrogen operated at a temperature above 400° C.

According to another aspect, a catalyst includes catalytically-active material including a formula: CeₓJ_{y}Q_{z}O₂₋ₙ, wherein Ce is Cerium, J includes at least one of Zirconium, Hafnium, Niobium, Tantalum, and Titanium, Q includes at least one of one or more metals and one or more metalloids, and O is oxygen; and wherein x, y, and z represent component mole fractions with respect to total moles of Ce, J, and Q; and wherein x ranges from 0.4 to 0.999, y ranges from 0.001 to 0.60, z ranges from 0.001 to 0.2, and n ranges from 0 to 0.5; and a support.

According to another aspect, a method for performing a reverse-water gas shift reaction includes contacting a feed stock with a catalyst at a temperature above 400° C., sufficient to generate a reaction product, wherein the feed stock includes carbon dioxide and hydrogen, the reaction product includes carbon monoxide and water, and the catalyst includes (1) catalytically active material including a formula: CeJQO, wherein Ce is Cerium, J includes at least one of Zirconium, Hafnium, Niobium, Tantalum, and Titanium, Q includes at least one of Praseodymium, Terbium, Thulium, Europium, Samarium, Ytterbium, Gallium, Germanium, Indium, Tin, Antimony, and Bismuth, and O is oxygen, and (2) a support.

According to another aspect, a system for producing hydrocarbon products includes (1) an electrolysis unit capable of receiving a water feed stream and producing a hydrogen product stream and an oxygen product stream; (2) a reverse-water gas shift unit disposed downstream of and in fluid communication with the electrolysis unit, the reverse-water gas shift unit being capable of producing a reverse-water gas shift product stream, wherein the reverse-water gas shift product stream includes carbon monoxide; (3) a water separations unit disposed downstream of and in fluid communication with the reverse-water gas shift unit, the water separations unit being capable of at least partially separating water from the reverse-water gas shift product stream sufficient to produce a water product stream and a refined syngas stream; (4) a carbon dioxide separations unit downstream of and in fluid communication with the water separations unit, wherein the carbon dioxide separations unit is capable of receiving the refined syngas stream and producing a carbon dioxide product stream and a purified syngas stream; and (5) a Fischer-Tropsch unit downstream of the water separations unit, the Fischer-Tropsch unit being capable of producing a hydrocarbon synthesis product stream, wherein the hydrocarbon synthesis product stream includes hydrocarbons.

According to another aspect, a method for processing a feed stock to produce liquid fuel includes producing a hydrogen product stream and an oxygen product stream from a water feed stream including water; mixing the hydrogen product stream and a carbon dioxide reactant stream to form a mixed reactant stream; heating the mixed reactant stream; producing a reverse-water gas shift product stream in a reverse-water gas shift unit by contacting the mixed reactant stream with a catalyst at a temperature above about 400° C., wherein heating the mixed reactant stream includes exchanging heat between the reverse-water gas shift product stream and the mixed reactant stream; and separating water from the reverse-water gas shift product stream to produce a refined syngas stream; producing a hydrocarbon synthesis product stream using a Fischer-Tropsch unit, wherein the hydrocarbon synthesis product stream includes hydrocarbons.

### BRIEF DESCRIPTION OF DRAWINGS

This written disclosure describes illustrative embodiments that are non-limiting and non-exhaustive. Reference is made to illustrative embodiments that are depicted in the figures, in which:

FIG. 1 illustrates method 100 for processing a feed stock, according to some embodiments.

FIG. 2 illustrates method 200 for making a catalyst, according to some embodiments.

FIG. 3A illustrates a side cut-away view of reactor 300, which shows a plurality of different catalytic species arranged or positioned within the internal reaction volume, according to some embodiments.

FIG. 3B illustrates a side cut-away view of reactor 350, which shows a plurality of different catalytic species arranged or positioned within the internal reaction volume, according to some embodiments.

FIG. 3C illustrates a side cut-away view of reactor system 370, which shows a reactor chamber and a catalyst, according to some embodiments.

FIG. 4 illustrates a thermal gradient reactor 400, according to some embodiments.

FIG. 5A illustrates a perspective view of return conduit 500 having a single helix or spiral configuration, according to some embodiments.

FIG. 5B illustrates a simplified side view of reactor 520 of the present invention that includes multiple return conduits (return conduits shown in phantom), according to some embodiments.

FIG. 5C illustrates a simplified side view of reactor 550 of the present invention that also includes multiple return conduits, according to some embodiments.

FIG. 6 illustrates a heterogeneous catalytic reactor 650, according to some embodiments.

FIG. 7 illustrates fuel production system 700, according to some embodiments.

FIG. 8 illustrates fuel production system 800, according to some embodiments.

FIG. 9 illustrates fuel production system 900, according to some embodiments.

FIG. 10 illustrates fuel production system 1000, according to some embodiments.

FIG. 11 illustrates method 1100 for processing a feed stock to produce liquid fuel, methanol, and/or higher alcohols, according to some embodiments.

FIG. 12 illustrates a comparison of reverse-water gas shift (RWGS) CO₂ conversions of various catalysts at different temperatures, according to some embodiments.

FIG. 13 illustrates a comparison of RWGS CO₂ conversions of various catalysts and no catalyst, according to some embodiments.

FIG. 14 illustrates the catalyst selectivity for RWGS of various catalysts, according to some embodiments.

FIG. 15 illustrates conversion of CO₂ and catalyst selectivity for the RWGS reaction for various catalysts as a function of pressure, according to some embodiments.

FIG. 16 illustrates catalyst selectivity for the RWGS reaction of a catalyst as a function of pressure, according to some embodiments.

FIG. 17 illustrates activation energy as a function of zirconium mol %, according to some embodiments.

FIG. 18 illustrates activation energy as a function of praseodymium mol %, according to some embodiments.

FIG. 19 illustrates catalyst performance over 70 days on-stream, according to some embodiments.

### DETAILED DESCRIPTION

### Definitions

As used herein, the terms “catalyst”, “catalytic material”, or the like refer to material which enables a chemical reaction to proceed at a faster rate or under different conditions (e.g., at a lower temperature) than otherwise possible. The catalysts of the present invention may include mixtures of two or more catalytic material(s) with other inert materials. The catalytic materials used in the present invention may be formed into desired shapes or sizes.

As used herein, the term “catalyst zone” or “catalytic zone” refer to portions of an internal reaction volume which exhibit one or more common environmental characteristics, such as the same or similar operating temperatures, same or similar operating pressures, and/or the presence of same or similar catalytic materials. Catalytic zones may also be referred to as catalytic regions, portions, or chambers.

As used herein, the phrase “direct fluid communication” refers to the ability of a fluid to flow from a first structure or location to a second structure or location without requiring the fluid to flow or migrate through an intermediary structure or location.

As used herein, the term “distal” refers to a feature or aspect of the present invention that is situated away from a point of reference (e.g., a point of attachment, origin, or a central point), while the term “proximal” refers to a feature or aspect of the invention that is situated near that point of reference.

As used herein, the terms “fluid” or “fluids” refer to a liquid, a supercritical fluid, a gas, or a slurry.

As used herein, the phrase “indirect fluid communication” refers to the ability of a fluid to flow from a first structure or location to a second structure or location but only if the fluid first flows or migrates through an intermediary structure or location to reach the second structure or location.

### DISCUSSION

The reverse water gas shift reaction (RWGS) is an endothermic reaction producing syngas and water from carbon dioxide and hydrogen. The RWGS reaction typically operates at temperatures above 400° C. For example, methanation may occur alongside the RWGS reaction at temperatures below 800° C. in the presence of carbon dioxide and hydrogen gas. This methanation wastes high-value feedstock hydrogen gas and is fairly inert requiring downstream purification or processing to stop it from building up in recycling loops. The RWGS produces syngas, which may be utilized for the Fischer-Tropsch, ethanol, and methanol production processes. Therefore, it is desirable to utilize a catalyst capable of reducing or preventing undesired side reactions while maintaining a high selectivity for the RWGS reaction. The RWGS reaction is shown in Equation 1.

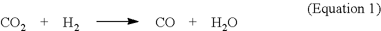

The present disclosure provides a novel catalyst for catalytic reactions. This catalyst is capable of operating at moderate to high temperatures (such as above about 400° C.) and catalyzing the RWGS reaction with high selectivity and stability. Under conditions that would normally produce substantial methanation as a by-product, the present catalyst is capable of reducing or preventing methane production. For example, the present invention can utilize catalytic materials that are highly selective for a desired RWGS reaction product, even at relatively high reaction pressures and/or temperatures, thereby eliminating or reducing the size of downstream unit operations (e.g., separation units). The output stream from the reactor includes an increased purity of desired products, preventing the need to add additional downstream units, such as methane removal units. Therefore, the capital and operating costs of the process are decreased.

Embodiments of the present disclosure provide novel cerium-containing catalysts. These cerium-containing catalysts can include catalytically active material (including cerium) and a support. For example, the cerium-containing catalyst (may be referred to hereafter as “catalyst”) can include cerium oxide and a support. These catalysts are stable at high temperatures, which is optimal for endothermic reactions. Further, the catalysts may be utilized with a variety of operating temperatures and pressures (gauge or absolute). This allows the catalyst to operate efficiently throughout various conditions and reaction times.

The catalyst can include catalytically-active material including a formula: CeJQO, wherein Ce is Cerium, J includes at least one of Zirconium, Hafnium, Niobium, Tantalum, and Titanium, Q includes at least one of one or more metals and one or more metalloids, and O is oxygen. The one or more metals can be selected from Praseodymium, Terbium, Thulium, Europium, Samarium, Ytterbium, Gallium, Indium, Tin, and Bismuth. These one or more metals can be redox active. The one or more metalloids can be selected from Germanium and Antimony. These one or more metalloids can be redox active. Accordingly, Q can include at least one of Praseodymium, Terbium, Thulium, Europium, Samarium, Ytterbium, Gallium, Germanium, Indium, Tin, Antimony, and Bismuth.

In one example, J includes at least one of Zirconium, Hafnium, and Niobium. In another example, J includes two or more of Zirconium, Hafnium, and Niobium. In yet another example, J includes Zirconium. In one example, Q includes at least one of Praseodymium, Terbium, and Bismuth. In another example, Q includes two or more of Praseodymium, Terbium, and Bismuth. In yet another example, Q includes Praseodymium.

The catalytically-active material can include the formula: CeₓJ_{y}Q_{z}O₂₋ₙ, where x, y, and z represent component mole fractions with respect to total moles of Ce, J, and Q. The mol fraction can be multiplied by 100 to calculate the mol %. Generally, n ranges from 0 to 0.5. For example, the value of (2-n) can be dependent upon synthesis and reaction conditions. For example, since the catalyst is redox active, some, all, or none of the metal oxides (such as cerium, praseodymium, and others of the present disclosure) can be fully reduced or oxidized. Therefore, in one example, when n is 0, the system is fully oxidized (such as a +4 oxidation state). In another example, when n is 0.5, the system is fully reduced (such as a +3 oxidation state). A value for n between 0 and 0.5 can represent a mix of +3 and +4 oxidation states.

In one example, x is greater than about 0.4. In another example, x is greater than about 0.7. In another example, x is greater than 0.9. In another example, x is greater than 0.95. In one example, y is greater than 0.001. In another example, y is greater than 0.003. In another example, y is less than 0.4. In another example, y is less than 0.3. In one example, z is greater than 0.001. In another example, z is greater than 0.004. In yet another example, z is less than 0.1.

In one example, x ranges from 0.1 to 0.999, y ranges from 0.001 to 0.70, z ranges from 0.001 to 0.5, and n ranges from 0 to 0.5. In another example, x ranges from 0.3 to 0.999, y ranges from 0.001 to 0.70, z ranges from 0.001 to 0.5, and n ranges from 0 to 0.5. In another example, x ranges from 0.4 to 0.999, y ranges from 0.001 to 0.60, z ranges from 0.001 to 0.5, and n ranges from 0 to 0.5. In another example, x ranges from 0.4 to 0.999, y ranges from 0.001 to 0.60, z ranges from 0.001 to 0.2, and n ranges from 0 to 0.5. In yet another example, x ranges from 0.5 to 0.999, y ranges from 0.001 to 0.3, z ranges from 0.001 to 0.2, and n ranges from 0 to 0.5. In yet another example, x ranges from 0.7 to 0.999, y ranges from 0.003 to 0.3, z ranges from 0.004 to 0.1, and n ranges from 0 to 0.5. In yet another example, x ranges from 0.9 to 0.999, y ranges from 0.001 to 0.1, and z ranges from 0.001 to 0.05.

J can include Zirconium, wherein y ranges from 0.001 to 0.3. J can include Niobium, wherein y ranges from 0.001 to 0.3. For example, J can include Niobium, wherein y ranges from 0.001 to 0.1. J can include Hafnium, wherein y ranges from 0.001 to 0.3. For example, J can include Hafnium, wherein y ranges from 0.001 to 0.1. The one or more metals (for Q) can include Bismuth, wherein z ranges from 0.001 to 0.1. For example, the one or more metals (for Q) can include Bismuth, wherein z ranges from 0.001 to 0.05. The one or more metals (for Q) can include Terbium, wherein z ranges from 0.001 to 0.1. For example, the one or more metals (for Q) can include Terbium, wherein z ranges from 0.001 to 0.05. The one or more metals (for Q) can include Praseodymium, wherein z ranges from 0.001 to 0.1.

In one non-limiting example, the catalyst includes cerium-zirconium-praseodymium oxide. In one non-limiting example, the catalyst includes the following formula: Ce_{0.8}Zr_{0.175}Pr_{0.025}O₂. In another non-limiting example, the catalyst includes the following formula: Ce_{0.65}Zr_{0.25}Pr_{0.1}O₂. In another non-limiting example, the catalyst includes the following formula: Ce_{0.965}Zr_{0.03}Pr_{0.005}O₂. In another non-limiting example, the catalyst includes the following formula: Ce_{0.9873}Zr_{0.0077}Bi_{0.005}O₂. In another non-limiting example, the catalyst includes the following formula: Ce_{0.9916}Nb_{0.0034}Pr_{0.005}O₂. In another non-limiting example, the catalyst includes the following formula: Ce_{0.98945}Hf_{0.00555}Pr_{0.005}O₂. In another non-limiting example, the catalyst includes the following formula: Ce_{0.989}Zr_{0.006} Tb_{0.005}O₂. In another non-limiting example, the catalyst includes the following formula: Ce_{0.73}Zr_{0.2458}Pr_{0.0227}O₂.

In one example, the catalyst includes catalytically-active material without a support. In another example, the catalyst may include catalytically active material, wherein the catalytically active material is about 2 wt. % to about 100 wt. % of the total weight of the catalyst (the support may be the remaining weight of the catalyst). In another example, the catalyst may include catalytically active material and a support, wherein the catalytically active material is about 3 wt. % to about 50 wt. % of the total weight of the catalyst (the support is the remaining weight of the catalyst). In yet another example, the catalyst may include catalytically active material and a support, wherein the catalytically active material is about 15 wt. % to about 50 wt. % of the total weight of the catalyst (the support is the remaining weight of the catalyst).

The catalyst may include cerium, zirconium, and praseodymium oxide on a support, wherein the cerium, zirconium, and praseodymium oxide are about 5 wt. % to about 60 wt. % of the total weight of the catalyst (the support is the remaining weight of the catalyst). For example, the catalyst may include cerium, zirconium, and praseodymium oxide on a support, wherein the cerium, zirconium, and praseodymium oxide are about 10 wt. % to about 55 wt. % of the total weight of the catalyst (the support is the remaining weight of the catalyst). For example, the catalyst may include cerium, zirconium, and praseodymium oxide on a support, wherein the cerium, zirconium, and praseodymium oxide are about 15 wt. % to about 50 wt. % of the total weight of the catalyst (the support is the remaining weight of the catalyst).

In one example, one or more additional elements may be added to the catalyst composition. For example, one or more transition metals, alkali and alkaline earths, and trivalent rare earth elements may be added to the catalyst composition. Transition metals may be added as dopants and/or as co-catalytic materials. These transition metals may include one or more of Chromium, Manganese, Iron, Nickel, Copper, Zinc, Molybdenum, and Silver. These transition metals may be added in the lattice of ceria (cerium oxide) and may improve catalytic activity and stability.

Alkali and/or alkaline earth elements may be added as dopants and/or as co-catalytic materials. Examples of alkali and/or alkaline earth elements include Beryllium, Magnesium, Calcium, Strontium, Barium, Sodium, Potassium, Rubidium, and Caesium. These may be introduced into the ceria lattice to increase the formation of oxygen vacancies. Trivalent rare earth elements, such as Yttrium, Neodymium, Promethium, Gadolinium, Dysprosium, Holmium, Erbium, and Lutetium, can be added. The type of dopant and the degree of doping depend on the application of the base catalyst. The degree of doping may be important as excessive elemental doping may result in a reduction in oxygen vacancies and thus a decrease in oxygen storage capacity for catalytic activity. Elements presented in the current paragraph can be in the form of oxides in the catalytic system.

Ceria (which may have a fluorite structure) and zirconia may have complex phase diagrams, where different crystal structures can form with different formulations and at different temperatures. In one example, pure zirconium oxide may be in the monoclinic phase, the tetragonal (t or t′) phase, and/or the cubic phase. Transitions between phases may lead to a volume increase, which may lead to cracks. Metastable tetragonal phases may be prepared by reduction and successive oxidation of the tetragonal phase. Metastable phases may make it possible to retain or obtain various physical properties of materials without changing the chemical composition. In one example, reduction may cause a phase transition. Catalysts of the present disclosure may optionally be stabilized by the oxides of calcium, cerium, magnesium, aluminum, hafnium, and yttria (yttrium oxide). Additionally, routes to mechanically stabilized and/or improved properties for catalysis may result from formulations and synthetic procedures that can alter grain growth, stabilize a specific crystal phase, and result in a majority of a desired crystalline facet. Further, the size and morphology may have significant effects on reaction stability and reactivity. Examples of morphologies include spheres, cubes, and rods.

The support may include any compound sufficient for chemical catalysis. In one example, the support includes alumina. In another example, the support includes one or more of aluminosilicate, zirconium oxide, silicon carbide, steatite, magnesium aluminate, cordierite, magnesium oxide, calcium oxide, potassium oxide, sodium oxide, strontium titanate, aluminum titanate, and yttrium oxide. In yet another example, the support includes alpha-phase alumina. Alpha-phase alumina may be in its most thermally-stable structural phase, which means that it will not undergo phase change during high temperature operation. For example, this alpha-phase alumina may be a porous, alpha-phase alumina sufficient to support the catalytically active material. The support may include a porous, alpha-phase alumina support bead. The catalytically active material may form one or more layers substantially surrounding the support. The catalytically active material may be a coating on the entire surface area of the porous support (in contact with the walls of the pores). In one non-limiting example, the support includes alpha-alumina and/or magnesium aluminate.

The support may further include a layer or oxide of one or more of magnesium, potassium, and calcium. In one example, magnesium may be added to a surface of the support as a base layer, such as a layer prior to adding catalytically active material. Therefore, magnesium may be added to an outer surface and/or may be placed in contact with the support within pores of the support. For example, adding magnesium may change the alkalinity of the support. A surface layer of magnesium aluminate can form from the magnesium oxide on top of aluminum oxide. Further, adding magnesium may eliminate and/or reduce imperfections in and/or on the support.

In one example, the specific surface area of the support may be between 2 m²/g and 150 m²/g. In another example, the specific surface area of the support may be between 5 m²/g and 100 m²/g. In yet another example, the specific surface area of the support may be less than about 12 m²/g. In one example, the support may include a median pore diameter ranging from about 0.01 micron to about 50 microns. In another example, the support may include a median pore diameter ranging from about 0.05 micron to about 5 microns. In yet another example, the support may include a median pore diameter ranging from about 0.1 micron to about 0.3 micron.

The support may be in the form of a support bead. For example, the support may include a substantially spherical support bead. The shape of the support bead may be shapes other than a sphere, such as a cylindrical shape or a ring. The catalyst may be in the form of porous beads, pellets, tubes, Raschig rings, Super Raschig rings, Pall rings, Bialecki rings, extrudates, lobes, saddles, and/or other shapes. The catalytically active material may substantially surround the support in the form of one or more layers. For example, the catalytically active material may entirely surround the support bead. In one example, the catalytically active material may be in the form of nanoparticles or microparticles in contact with the support. In one example, the catalyst beads have a diameter ranging from about 1 mm to about 10 cm. In another example, the catalyst beads have a diameter ranging from about 1 mm to about 2 cm. In yet another example, the catalyst beads have a diameter ranging from about 2 mm to about 4 mm. For example, the diameter of the catalyst beads may be about 2 mm, about 2.5 mm, about 3 mm, about 3.5 mm, or about 4 mm. These catalyst beads may be any catalyst shape of the present disclosure. In another example, the catalyst can be in the form of trilobe extrudates. The diameter of the trilobe extrudates can range from about 0.1 mm to about 20 mm. In one example, the diameter of the trilobe extrudates can range from about 0.1 mm to about 5 mm.

Catalysts of the present disclosure may be utilized for the RWGS reaction. The RWGS reaction is an endothermic reaction producing syngas from carbon dioxide and hydrogen. Carbon monoxide and water are produced from the RWGS reaction. The RWGS reaction may require elevated temperatures and pressures, and two of the biggest challenges with the RWGS reaction involves sintering and coking. Catalysts of the present disclosure, such as the cerium-containing catalysts, include unique oxygen transport properties. These oxides can react with hydrogen gas to form water, whereby removing an oxygen from the cerium to form a partially-reduced metal oxide. This oxygen vacancy can move around the lattice to perform other reactions if necessary and can stably store this oxygen deficit until CO₂ binds. In one example, these catalysts include non-stoichiometric quantities, causing lattice distortion. This can assist in elevating the performance of the catalyst for the RWGS reaction.

In one example, the catalyst includes cerium, zirconium, and praseodymium, and the mol % of zirconium with respect to the total moles of cerium, zirconium, and praseodymium is less than 15 mol %. Since the RWGS reaction is two-step, zirconium can help promote the reduction with hydrogen. This step is not the slower step in the reaction, and so it may not be useful in amounts higher than 15%. Further, at temperatures above about 1000° C., zirconium may exhibit phase separation if the mol % is greater than about 15 mol %. Praseodymium oxide forms a mixed valence cubic oxide with a variable lattice parameter that can by tuned by varying conditions. Importantly, the addition of praseodymium provides an increase in catalyst performance. Cerium and praseodymium are redox active in such a way to allow for a broad range of catalyst activation. In one non-limiting example, cerium, praseodymium, and zirconium in the present catalysts lack active d-orbitals. This can assist in being active for the RWGS reaction, but not other unwanted reactions. This increases the overall selectivity of the catalysts of the present disclosure. Active d-block orbitals may assist other catalysts in catalyzing unwanted reactions.

Catalysts of the present disclosure are capable of catalyzing the RWGS reaction while resisting coking and methanation. In one example, the catalyst has greater than 80% selectivity for carbon monoxide formation in a mixture of carbon dioxide and hydrogen. In another example, the catalyst has greater than 90% selectivity for carbon monoxide formation in a mixture of carbon dioxide and hydrogen. In yet another example, the catalyst has greater than 95% selectivity for carbon monoxide formation in a mixture of carbon dioxide and hydrogen. For example, the catalyst may have greater than 96%, greater than 97%, greater than 98%, or greater than 99% selectivity for carbon monoxide formation in a mixture of carbon dioxide and hydrogen. The catalyst may have greater than 99%, greater than 99.1%, greater than 99.2%, greater than 99.3%, greater than 99.4%, greater than 99.5%, greater than 99.6%, greater than 99.7%, greater than 99.8%, greater than 99.9%, or percentages therebetween, selectivity for carbon monoxide formation in a mixture of carbon dioxide and hydrogen. These selectivity values may be measured at a temperature above 400° C.

In one example, the catalyst is capable of a CO₂ conversion to CO of greater than 25% at 500° C., 1.01 bar, and at an H₂/CO₂ ratio of 2. In another example, the catalyst is capable of a CO₂ conversion to CO of greater than 40% at 550° C., 1.01 bar, and at an H₂/CO₂ ratio of 2. In another example, the catalyst is capable of a CO₂ conversion to CO of greater than 50% at 600° C., 1.01 bar, and at an H₂/CO₂ ratio of 2. In yet another example, the catalyst is capable of a CO₂ conversion to CO of greater than 55% at 700° C. and greater than 60% at 800° C., 1.01 bar, and at an H₂/CO₂ ratio of 2. Importantly the catalyst is capable of these CO₂ conversions while being inert to methanation. The catalyst may be utilized for the RWGS reaction operated at a pressure ranging from about 1 bar to about 40 bar. In one example, the input ratio of H₂/CO₂ ranges from about 1.5 to about 2.5. In another example, the input ratio of H₂/CO₂ ranges from about 1.8 to about 2.3. In yet another example, the input ratio of H₂/CO₂ is about 2.

Catalysts of the present disclosure are capable of catalyzing reactions at temperatures conventional catalysts are not capable of or at temperatures that conventional catalysts would produce substantial methane product. Further, the previously mentioned selectivity is maintained across a range of temperatures and pressures. In one example, the catalyst may be utilized for the RWGS reaction operated at a temperature above 400° C. In another example, the catalyst may be utilized for the RWGS reaction operated at a temperature ranging from about 400° C. to 2000° C. In yet another example, the catalyst may be utilized for the RWGS reaction operated at a temperature ranging from about 500° C. to 800° C. For example, the catalyst may be utilized for the RWGS reaction operated at a temperature of about 550° C., about 600° C., about 650° C., about 700° C., about 750° C., about 800° C., about 850° C., or temperatures therebetween. The catalyst may be utilized for the RWGS reaction operated at a temperature below 850° C., below 800° C., below 750° C., or below 700° C. The catalyst may be utilized for the RWGS reaction operated at a temperature above 400° C., above 450° C., above 500° C., or above 550° C. The catalyst may be utilized for the RWGS reaction operated at a temperature above 600° C., above 750° C., above 900° C., or above 1100° C. The catalyst may be utilized for the RWGS reaction operated at a temperature above 800° C., above 950° C., above 1200° C., or above 1500° C.

Catalysts of the present disclosure are capable of catalyzing reactions at various operating pressures. The catalyst may be utilized for the RWGS reaction operated at a pressure above 1 bar. In one example, the catalyst may be utilized for the RWGS reaction operated at a pressure ranging from about 1 bar to about 40 bar. In another example, the catalyst may be utilized for the RWGS reaction operated at a pressure ranging from 5 bar to 20 bar. In yet another example, the catalyst may be utilized for the RWGS reaction operated at a pressure ranging from 1 bar to 4 bar. The catalyst may be utilized for the RWGS reaction operated at a pressure above 1 bar, above 2 bar, above 3 bar, above 4 bar, or above 5 bar. As the pressure increases in the RWGS reaction, side reactions may become more prevalent in traditional catalytic reactions. Further, conventional catalysts are only utilized for the RWGS reaction at temperatures above about 850° C. to avoid side reactions. These conventional catalysts suffer from coking and sintering at lower temperatures during non-ideal reactor system interruptions. For example, during non-ideal reactor system interruptions where the temperature drops below about 800° C. or below about 850° C., the reactants and conventional catalyst cause a failure if the reaction persists for a length of time at this lower temperature. In contrast, the catalysts of the present disclosure do not cause such failures if the reactor temperature varies.

Methanation represents a chemical reaction of converting carbon monoxide and carbon dioxide to methane through hydrogenation. In one example, the catalyst is completely or substantially inert to methanation. In this example, the catalyst itself can causes 0% or near 0% methanation. The catalyst can be used while not showing methanation products. The catalyst itself may cause less than 2% methanation. In another example, less than 10% of the total carbon dioxide is converted to methane in the RWGS reaction. In yet another example, less than 5% of the total carbon dioxide is converted to methane in the RWGS reaction. In yet another example, less than 1% of the total carbon dioxide is converted to methane in the RWGS reaction. Even though the percentage of total carbon dioxide converted to methane in the RWGS reaction is slightly above zero, the catalyst itself may still cause zero methanation. This is due to possible background methanation by interactions between the reactants and the reactor walls and/or materials. For example, if 2% of the total carbon dioxide is converted to methane in the RWGS reaction, the catalyst itself may be completely inert to this methanation process and the reactor materials may cause all methanation, or the catalyst itself may contribute to about 1% of the methanation and the reactor materials may contribute the other 1%. The RWGS reaction may produce less than 1.5% methane, less than 1.25% methane, less than 1% methane, less than 0.5% methane, or 0% methane.

The catalyst may be used in various types of reactor vessels. Examples of reactor vessels may include an isothermal reactor, a thermal gradient reactor, a fixed-bed reactor, and a fluidized bed reactor. For example, the catalyst may be used in an isothermal reactor at a temperature setpoint, such as between 500° C. and 800° C., where methanation would normally occur with traditional catalysts. The catalyst may be utilized in a single reactor with one or more reaction zones, wherein the one or more reaction zones are configured to establish a thermal gradient along the length of the chamber. The catalyst may be utilized for two or more discrete reaction zones, wherein the two or more discrete reaction zones form a thermal gradient. In one example, the catalyst may be used in a thermal gradient reactor at a section/zone of the reactor where temperatures normally cause methanation. The catalyst may lower the activation energy of the reaction. In one example, the catalyst system including praseodymium may lower the activation energy. Lowering the activation energy of the reaction can increase the kinetic rate of reaction. This may be validated by the Arrhenius nature of the reaction kinetics.

By using the present catalysts, downstream purification, such as methane removal, may be removed. Additionally, or alternatively, downstream ratio adjustment steps may be removed. Importantly, the only purification that may be required is removal of water. Therefore, the process requires less unit operations between downstream processes. Since the RWGS reaction produces valuable syngas, this syngas may be utilized for the Fischer Tropsch process, methanol production, and ethanol production. By decreasing the overall purification steps, the capital and operating costs decrease. Additionally, a greater purity of desired products may be produced at downstream processes.

Compared to a traditional nickel catalyst that makes methane during the RWGS reaction, the present catalysts produce little to no methane. To avoid side reactions, catalysts are utilized at very high temperatures. Further, these traditional catalysts suffer from coking problems and are not stable for long run times. Since the present catalysts are stable and are coke-resistant, the catalyst does not need to be replaced as often as a conventional catalyst. Importantly, under conditions that would normally produce substantial methanation as a by-product with catalysts based on nickel or iron, the present catalysts have little to no methanation. The catalysts of the present disclosure are capable of operating in a wider range of temperatures and pressures, all while resisting coking and methanation. Due to the high selectivity of the catalysts, the output stream from the reaction may only contain carbon dioxide, carbon monoxide, hydrogen, and water. This allows for high carbon utilization for the desired reaction scheme and may remove the need for downstream purification, beyond removal of water. This may reduce overall capital and operating costs, and this may simplify the use of syngas downstream. Additionally, the catalysts are stable at high temperatures, which is optimal for endothermic reactions.

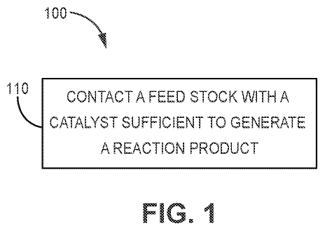

Referring to FIG. 1, a method 100 of processing a feed stock is illustrated, according to some embodiments. The method 100 includes the following steps:

STEP 110, CONTACT A FEED STOCK WITH A CATALYST, SUFFICIENT TO GENERATE A REACTION PRODUCT, includes contacting a feed stock, such as carbon dioxide and hydrogen, with a catalyst of the present disclosure, sufficient to generate a reaction product, such as carbon monoxide and water. The feed stock may include one or more of carbon dioxide, hydrogen, and methane. The reaction product may include one or more of carbon monoxide, water, and hydrogen. In one example, the catalyst includes catalytically active material and a support. Contacting the feed stock with the catalyst may occur at a temperature above about 400° C. In one example, contacting the feed stock with the catalyst may occur at a temperature ranging from 500° C. to 2000° C. In another example, contacting the feed stock with the catalyst may occur at a temperature ranging from 600° C. to 800° C.

Method 100 may include the RWGS reaction. The RWGS reaction is an endothermic reaction producing syngas from carbon dioxide and hydrogen. Carbon monoxide and water are produced from the RWGS reaction. Therefore, the feed stock in method 100 may be hydrogen and carbon dioxide, and the reaction product may be carbon monoxide. The RWGS reaction may require elevated temperatures and pressures. Two of the biggest challenges with RWGS involves sintering and coking.

Method 100 may include generating the reaction product without one or more of methanation and catalyst coking. In one example, contacting the catalyst with carbon dioxide and hydrogen produces less than 10% methane at a temperature above 400° C. and a pressure between 1 bar and 40 bar. In another example, contacting the catalyst with carbon dioxide and hydrogen produces less than 5% methane at a temperature above 400° C. and a pressure between 1 bar and 40 bar. In yet another example, contacting the catalyst with carbon dioxide and hydrogen produces less than 2% methane at a temperature above 400° C. and a pressure between 1 bar and 40 bar. For example, the reaction may produce less than 1.5% methane, less than 1.25% methane, less than 1% methane, less than 0.5% methane, or 0% methane at the temperatures and pressures of the present disclosure. Additionally, the catalyst may be coke-resistant and/or coke-free during the RWGS reaction.

Method 100 may include generating the reaction product at a pressure between 1 bar and 40 bar. For example, generating the reaction product may occur at a pressure between 10 and 30 bar. STEP 110 may include generating the reaction product in a reactor selected from an isothermal reactor and a thermal gradient reactor. In one example, the catalyst has greater than 80%, greater than 85%, greater than 90%, or greater than 95% selectivity for carbon monoxide formation. For example, the catalyst may have greater than 95.5%, greater than 96%, greater than 96.5%, greater than 97%, greater than 97.5%, greater than 98%, and/or greater than 98.5% selectivity for carbon monoxide formation. In another example, the catalyst has greater than 99% selectivity for carbon monoxide formation. For example, the catalyst may have greater than 99.5% selectivity for carbon monoxide formation.

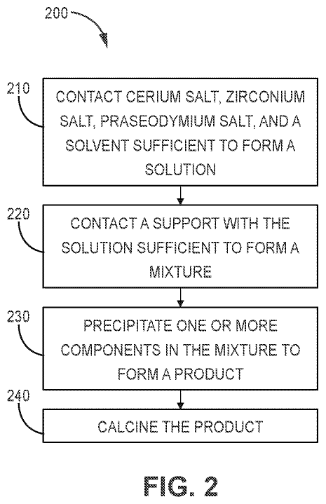

Referring to FIG. 2, a method 200 of making a catalyst is illustrated, according to some embodiments. Method 200 illustrates one example method and is not exhaustive. Method 200 is sufficient to form catalysts of the present disclosure. The method 200 includes the following steps:

STEP 210, CONTACT CERIUM SALT, ZIRCONIUM SALT, PRASEODYMIUM SALT, AND A SOLVENT SUFFICIENT TO FORM A SOLUTION, includes contacting cerium salt, zirconium salt, praseodymium salt, and a solvent, such as water, sufficient to form a mixture/solution. In one example, the cerium salt, zirconium salt, and praseodymium salt include nitrate salts. For example, cerium nitrate, zirconium dinitrate oxide, and praseodymium nitrate may be contacted with water sufficient to form the solution. The nitrate salts may be dissolved in distilled water. Nitrate salts may be dissolved in a solvent followed by sonication and impregnation using a stirrer. STEP 210 may be completed at room temperature or at a temperature above room temperature. For example, STEP 210 may be completed at a temperature between 25° C. and 45° C. To form other catalysts of the present disclosure, this step may be performed by utilizing the corresponding salts of other metals/metalloids (discussed herein). At various portions of method 200, glycine and/or urea may be added to react with metal nitrate salts.

STEP 220, CONTACT A SUPPORT WITH THE SOLUTION SUFFICIENT TO FORM A MIXTURE, includes contacting a support, such as an alumina support, with the solution sufficient to form a mixture/solution. STEP 220 may be completed at room temperature or at a temperature above room temperature. For example, STEP 220 may be completed at a temperature between 25° C. and 45° C. In one example, STEP 220 is completed at a constant temperature of 40° C. STEP 220 may also be completed simultaneously with STEP 210. The support may include a support of the present disclosure. The support may include one or more of aluminosilicate, zirconium oxide, silicon carbide, steatite, magnesium aluminate, cordierite, magnesium oxide, calcium oxide, potassium oxide, sodium oxide, strontium titanate, aluminum titanate, and yttrium oxide. In one example, the support includes a porous, alpha-phase alumina support bead. The support may include magnesium in contact with the surface of the support.

STEP 230, PRECIPITATE ONE OR MORE COMPONENTS IN THE MIXTURE TO FORM A PRODUCT, includes precipitating one or more components, such as the catalyst components, to form a product. In one example, the catalyst components are precipitated into pores of the support. In another example, the catalyst components are placed in permanent contact with the support surface during precipitation. For example, STEP 230 may include controlled stirring followed by heating, such as heating for one or more hours, 5 or more hours, or 15 or more hours. Heating may include heating the mixture at/to a temperature above room temperature, such as a temperature above about 20° C. In another example, the catalyst components are precipitated into pores of an alumina ceramic support. The system may be dried by heating the system sufficient to remove water. The precipitation can be completed by removing water until the system is dry. Alternatively, chemical precipitation may be used while the material is still wet.

STEP 240, CALCINE THE PRODUCT, includes calcining the product to remove any undesired components. For example, calcination may remove residuals or junk from the catalyst. Residuals or junk may be salts, such as nitrate salts. These salts may be decomposed by calcination. In one example, calcination is completed at a temperature above 300° C. In another example, calcination is completed at a temperature between 500° C. and 1500° C. In yet another example, calcination is completed at about 300° C. for a first amount of time and at about 600° C. for a second amount of time. For example, calcination is completed at about 300° C. for an hour and at about 600° C. for two hours. Calcination may be completed in about one hour to about 20 hours. In one example, calcination is completed in about 2 hours to about 4 hours. Following calcination, the catalyst product may be slowly cooled to room temperature, such as about 20° C. If multi-layers are utilized, steps within method 200 can be repeated using the same or different materials.

A reaction vessel for producing syngas may include the catalyst of the present disclosure. This reaction vessel may include one or more reaction chambers, an inlet for receiving carbon dioxide and hydrogen, and an outlet for releasing carbon monoxide and water from the reaction vessel. The outlet may also release carbon dioxide and/or hydrogen. The catalyst in the reaction vessel may include catalytically active material and a support, wherein the catalyst is sufficient to convert the carbon dioxide and hydrogen to carbon monoxide and water. The reaction vessel may further include one or more reaction chambers maintained at a temperature above 400° C.

In one example, the one or more reaction chambers may include an isothermal reactor. In another example, the one or more reaction chambers include two or more reaction zones, each at a different temperature, sufficient to form a thermal gradient reaction vessel. At least one of the two or more reaction zones may be methane-free. In yet another example, the one or more reaction chambers may be configured to establish a thermal gradient along the length of the reaction chamber. For example, the thermal gradient vessel may be filled with the catalyst along the length of the reaction chamber, or the thermal gradient vessel may include the catalyst in a region/zone of the vessel. For example, the catalyst may be included in the reactor at a point where the temperature would normally cause methanation. Therefore, the catalyst may be used in conjunction with other distinct catalysts in a reaction vessel including two or more distinct catalysts.

The one or more reaction chambers may be maintained at a temperature above 300° C. In one example, at least one of the one or more reaction chambers is maintained at a temperature above 400° C. In another example, at least one of the one or more reaction chambers is maintained at a temperature between 500° C. and 2000° C. In yet another example, at least one of the one or more reaction chambers is maintained at a temperature between 550° C. and 700° C. At least one of the one or more reaction chambers may be maintained at a temperature of about 550° C., about 600° C., about 650° C., about 700° C., about 750° C., about 800° C., about 850° C., or temperatures therebetween. At least one of the one or more reaction chambers may be maintained at a temperature below 850° C., below 800° C., below 750° C., or below 700° C. At least one of the one or more reaction chambers may be maintained at a temperature above 400° C., above 450° C., above 500° C., or above 550° C.

In one example, the one or more reaction chambers are operated at a pressure ranging from about 1 bar to about 40 bar. In another example, the one or more reaction chambers are operated at a pressure ranging from 5 bar to 20 bar. In yet another example, the one or more reaction chambers are operated at a pressure ranging from 1 bar to 4 bar. The one or more reaction chambers are operated at a pressure above 1 bar, above 2 bar, above 3 bar, above 4 bar, or above 5 bar. These pressures may be present in an isothermal reactor or a thermal gradient reactor.

The reaction vessel may include the reaction vessels disclosed in PCT Application No. PCT/US2022/018266 filed on Mar. 1, 2022, the contents of which are incorporated by reference in its entirety.

A heterogeneous catalytic reactor may include an encasement having a length and a width, wherein the length extends from a distal portion of the encasement to a proximal portion of the encasement, and wherein the encasement defines an internal reaction volume. The reactor may include at least one inlet in the proximal portion of the encasement, wherein the at least one inlet defines a reactant flow channel that is in fluid communication with the internal reaction volume of the encasement. The reactor may include at least one conduit arranged within the internal reaction volume and extending from the proximal portion of the encasement toward the distal portion of the encasement, wherein the at least one conduit defines at least a portion of a return flow channel. The reactor may include at least one outlet in the proximal portion of the encasement in direct fluidic communication with the at least one conduit, wherein the at least one outlet defines at least a portion of the return flow channel. The length of the encasement may be greater than the width of the encasement. The reactor may include at least two species of catalyst material positioned within the internal reaction volume, wherein at least one of the species includes a cerium-containing catalyst of the present disclosure. Catalysts of the present disclosure may be used in various reactors of the present disclosure.

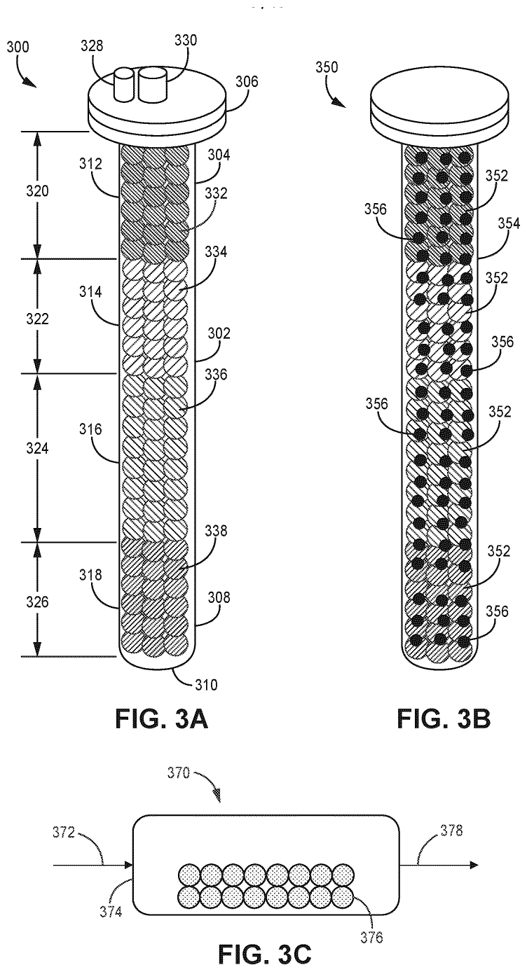

FIG. 3A illustrates a side cut-away view of reactor 300, which shows a plurality of different catalytic species arranged or positioned within the internal reaction volume, according to some embodiments. Reactor 300 includes encasement 302. Proximal portion 304 of encasement 302 includes proximal cap 306, while distal portion 308 of encasement 302 includes distal cap 310. Proximal cap 306 includes inlet 328 and outlet 330 and defines a proximal end of encasement 302. Outlet 330 is secured to and in direct fluid communication with a return conduit or a manifold joining a plurality of return conduits (not illustrated in FIG. 3A). Inlet 328 is in direct fluid communication with an internal reaction volume bounded by the inner walls of encasement 302 and the outer wall of the one or more return conduit(s).

The internal reaction volume of reactor 300 is filled with four different species of catalyst materials, including first catalyst material 332, second catalyst material 334, third catalyst material 336, and fourth catalyst material 338. Each of first, second, third, and fourth catalyst material 332, 334, 336, and 338 take the form of spherical particles or beads. At least one of the species of catalyst materials may include the cerium-containing catalyst of the present disclosure. Other catalysts, like copper-based catalysts, can be utilized in conjunction with the cerium-containing catalyst. While reactor 300 is illustrated with catalyst material 332, 334, 336, and 338 in the form of spherical particles or beads, some embodiments of the reactor may include catalyst material having other forms or shapes. For example, the reactors may include one or more catalyst materials in the form of porous beads, pellets, tubes, Raschig rings, Super Raschig rings, Pall rings, Bialecki rings, extrudates, lobes, saddles, and/or other shapes. In some embodiments, the catalyst material(s) include one more type of catalyst support material on or in which the catalytically active agent(s) is positioned. In some applications, the support material is, itself, catalytically active and participates in the conversion of reactant(s) to product(s).

First, second, third, and fourth catalyst material 332, 334, 336, and 338 are arranged sequentially, each in their own catalytic zone. Catalytic zones may also be referred to as catalytic regions or chambers. First catalyst material 332 is positioned within first catalytic zone 312, which occupies length 320 of the internal reaction volume of encasement 302. Second catalyst material 334 is positioned within second catalytic zone 314, which occupies length 322 of the internal reaction volume of encasement 302. Third catalyst material 336 is positioned within third catalytic zone 316, which occupies length 324 of the internal reaction volume of encasement 302. Fourth catalyst material 338 is positioned within fourth catalytic zone 318, which occupies length 326 of the internal reaction volume of encasement 302.

During operation, a thermal gradient can be established along the length of the internal reaction volume of the reactors such that distal portions of the internal reaction volume operate at a higher temperature than more proximal portions. The catalyst material arranged within each of the catalytic zones can be selected to increase or optimize the performance of the reactor at the temperature and/or pressure of that zone. For example, first catalytic zone 312 may be relatively cool compared to second, third, or fourth catalytic zones 314, 316, and 318, so first catalyst material 332 can be selected to include a material that catalyzes the reactant(s) more efficiently or optimally at that cooler temperature of zone 312. Similarly, fourth catalytic zone 318 may operate at a temperature that is greater than the temperature of the first, second, or third catalytic zones 312, 314, and 316, so fourth catalytic zone 318 can be selected to include a catalyst material that catalyzes the reactant(s) more efficiently or optimally at the higher temperature of zone 318.

The catalyst material arranged within each of the catalytic zones can be selected to meet or exceed a desired performance metric when the reactor is operating at steady state (i.e., the thermal gradients established within the reactor are no longer fluctuating). Examples of such performance metrics include amounts of catalytic conversion or catalytic selectivity. Further, the catalyst material may be selected based on the temperature of the zone and if the temperature is prone to methanation during the reaction. If, for example, an inventive reactor is being used to perform an RWGS reaction, the catalytic material in one or more of the catalytic zones could be chosen to provide a CO₂ conversion of at least 10%, at least 20%, at least 30%, at least 40%, at least 50%, at least 60%, at least 70%, at least 80%, at least 90%, or at least 95%, where CO₂ conversion for a given zone is defined according to the following Equation 2:

$${CO}_{2} Conversion \% = ( 1 - \frac{{CO}_{2 , out}}{{CO}_{2 , in}} ) * 100 \qquad ( Equation 2 )$$

Further, the catalytic material in one or more of the catalytic zones could be chosen to provide a certain fraction of the theoretical conversion maximum for CO₂ under the conditions of a given zone (e.g., the temperature, pressure, and chemical composition within a zone). For example, the catalytic material in a given zone could be chosen to provide at least 10%, at least 20%, at least 30%, at least 40%, at least 50%, at least 60%, at least 70%, at least 80%, at least 90%, or at least 95% of the theoretical conversion maximum for CO₂ under the reaction conditions of that zone.

Alternatively or in addition, the catalytic material in one or more of the catalytic zones could be chosen to provide a catalyst selectivity of at least 80%, at least 85%, at least 90%, at least 95%, or at least 99%, wherein catalyst selectivity for the RWGS reaction is defined for a given zone according to the following Equation 3:

$$RWGS , {Sel}_{CO} = \frac{{n}_{CO , out}}{{n}_{CO 2 , in} - {n}_{CO 2 , out}} \qquad ( Equation 3 )$$

In some embodiments, each of the catalytic zones comprises, consists essentially of, or consists of a species of catalyst material that is different from or dissimilar to the species of catalyst material arranged or positioned in any of the other catalytic zones. For example, the catalyst materials in a given zone may include different types and/or amounts of catalytic active agents, different types and/or amounts of catalyst support materials, different formulations, different concentrations, and/or different surface areas per given volume, as compared to the catalyst materials in the other catalytic zones. In further examples, the catalyst materials in a given catalytic zone may include different porosity and/or surface area as compared to the catalyst materials in other catalytic zones. In this way, the catalytic active agents and/or catalyst support materials of a given catalytic zone's catalyst material can be tuned to the temperatures and pressures found in that catalytic zone so as to provide for a desirable level of reaction performance.

In some embodiments, each catalytic zone extends along a portion of the length of the internal reaction volume of the encasement while occupying the entire width of that portion of the encasement. That is, in some embodiments of the invention, each catalytic zone can be arranged within the encasement such that there is no overlap between neighboring zones along the length of the internal reaction volume of the reactor and/or along the temperature gradient within the inner reaction volume of the reactor. In this way, some embodiments of the present reactor include only one species of catalyst material at a given reaction temperature.

While FIG. 3A illustrates an embodiment of the invention that includes four different catalytic zones, some embodiments of the invention includes a plurality of catalytic zones (e.g., 2, 3, 4, 5, 6, 7, 8, 9, 10, 11, 12, 13, 14, 15, 16, 17, 18, 19, 20, 21, 22, 23, 24, 25, 26, 27, 28, 29, 30, or more than 30 catalytic zones), each with its own specific composition and/or concentration of catalyst material having characteristics desirable for that zone (e.g., surface area, selectivity, specificity, kinetics, thermodynamics, pore size, thermal conductivity, thermal stability, chemical stability, or other catalytic characteristics). The different species of catalyst materials can be arranged in a predetermined sequential order with the performance characteristics of that species of catalyst material matched or paired with the operating conditions (e.g., temperature and/or pressure) in its respective catalytic zone. For example, catalyst material that provides better performance for a given reaction at relatively high temperatures can be positioned in catalytic zones near or at the distal end of the internal reaction volume of the reactor while catalysts better suited for lower operating temperature can be positioned in catalytic zones near the proximal portion the internal reaction volume of the reactor.

In some embodiments the support material for the catalyst includes a porous coating, such as porous coatings of silicon carbide and/or boron nitride. Such a porous coating can allow the infiltration of reactant fluids while also allowing for improved heat transfer among and between the catalyst particles and the fluids in the internal reaction volume. In some embodiments, the catalyst material is arranged within the pores of the support structure to increase the active surface area of the catalyst.

In some embodiments, the reactors of the present invention include inert filler particles (e.g., filler beads) that are distributed or arranged within the internal reaction volume. FIG. 3B illustrates one such embodiment in the form of reactor 350 (note parts of the reactor, such as inlets or outlets, are omitted in FIG. 3B for brevity). Reactor 350 includes encasement 354 which defines an internal reaction volume that includes a plurality of different bead-shaped catalyst materials 352 as well as a plurality of inert filler beads 356 positioned or arranged about the bead-shaped catalyst materials 352. Inert filler beads 356 may be made of a material that promotes conductive heat transfer (e.g., silicon carbide, alumina, boron nitride, copper, stainless steel, aluminum, aluminum nitride, aluminum oxynitride, and/or composites thereof). Inert filler beads 356 can assist in or improve the transfer of heat within the internal reaction volume, thereby helping to maintain a more uniform temperature gradient across the width of reactor 350. In some embodiments, up to 5%, 10%, 15%, 20%, 25%, 30%, 35%, 40%, 45%, or 50% of the volume of the internal reaction volume may be occupied by inert filler beads.

FIG. 3C illustrates a side cut-away view of reactor system 370, which shows a reactor chamber and a catalyst, according to some embodiments. Reactor system 370 is sufficient for the RWGS reaction and includes reactor inlet 372, reactor chamber 374, catalyst 376, and reactor outlet 378. Reactor inlet 372 may transfer one or more of carbon dioxide and hydrogen to the reactor chamber 374. The reactor chamber 374 may be isothermal or may have a thermal gradient across the length/width of the reactor chamber 374. The reactor chamber 374 may be any reactor shape/dimensions known to one skilled in the art. The reactor chamber includes a catalyst 376, such as a catalyst of the present disclosure. While catalyst 376 is shown as a substantially spherical bead, other shapes and sizes of catalyst 376 may be utilized. Catalyst 376 may have various loading amounts in reactor chamber 374, and may fill reactor chamber 374 more than illustrated in FIG. 3C. Further, reaction products including one or more of water and carbon monoxide exit the reactor chamber 374 via reactor outlet 378. As illustrated, the reactor inlet 372 and the reactor outlet 378 may be on opposite ends/sides of the reactor chamber 374. Alternatively, the reactor inlet 372 and the reactor outlet 378 may be on the same end/side of the reactor chamber 374.

In one example, the reactor chamber 374 may include an isothermal reactor operated at a temperature above about 400° C. and a pressure between 1 bar and 40 bar. In another example, the reactor chamber 374 may include two or more reaction zones, each at a different temperature, sufficient to form a thermal gradient reaction vessel, and wherein at least one of the two or more reaction zones is methane-free. Two or more reaction chambers 374 may be utilized in parallel or in series. In one example, reaction chamber 374 is maintained at a temperature between 500° C. to 2000° C. In another example, reactor chamber 374 is operated at a pressure between 1 bar and 40 bar. In one example, the catalyst 376 in reaction chamber 374 has greater than 80% selectivity for carbon monoxide formation in a mixture of carbon dioxide and hydrogen. In another example, the catalyst 376 in reactor chamber 374 has greater than 90% selectivity for carbon monoxide formation in a mixture of carbon dioxide and hydrogen. In yet another example, the catalyst 376 in reactor chamber 374 has greater than 95% selectivity for carbon monoxide formation in a mixture of carbon dioxide and hydrogen. In yet another example, the catalyst 376 in reactor chamber 374 has greater than 99% selectivity for carbon monoxide formation in a mixture of carbon dioxide and hydrogen.

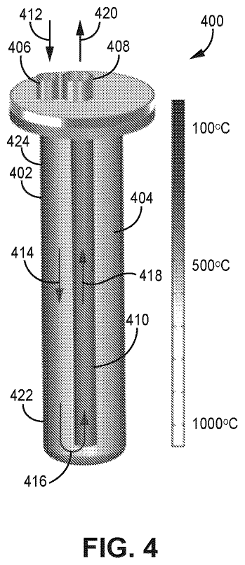

FIG. 4 illustrates a thermal gradient reactor 400, according to some embodiments. FIG. 4 shows only some of the major components of reactor 400 to better illustrate the bayonet design reactor flow paths and the temperature gradient that can be established in the reactors. One of skill in the art will readily appreciate that the components of the reactors that are not shown in FIG. 4 but are described elsewhere herein are equally applicable to the embodiment of reactor 400.

Reactor 400 includes encasement 402, inlet 406, and outlet 408. Encasement 402 is shown as partially translucent in FIG. 4 to better illustrate the internal structure of reactor 400. Encasement 402 is generally tubular in shape with its internal walls defining internal reaction volume 404. While encasement 402 is generally tubular in shape, in other embodiments the encasements of the present invention take other shapes, such as prismatic, hexagonal, or any other geometry which will promote segregation of heat within the internal reaction volume. Encasement 402 also includes distal portion 422 and proximal portion 424 opposite distal portion 422. Internal reaction volume 404 is the portion or area of reactor 400 in which catalytic reactions occur to convert reactant(s) to product(s) (catalyst materials are not illustrated in FIG. 4). Internal reaction volume 404 is also defined by the outer walls of return conduit 410. Return conduit 410 is arranged within, and spans most of the length of, encasement 402. A proximal end of return conduit 410 is attached to or otherwise secured against outlet 408 at or near the proximal end of encasement 402, while a distal end of return conduit 410 is positioned at or near the distal end of encasement 402. Collectively, the inner walls of return conduit 410 and outlet 408 define a return flow channel.

With regards to the fluidic flow path of reactor 400, during use one or more fluidic reactants are directed into a proximal portion of reactor 400 through inlet 406 along direction 412. The reactants then travel generally along direction 414 through internal reaction volume 404 along the length, and towards a distal portion, of reactor 400. While traveling through internal reaction volume 404, the reactants contact heterogeneous catalyst materials and undergo catalytic reactions to produce one or more products (e.g., one or more fluidic products). Once in the distal portion of reactor 400, the reactant(s) and/or formed reaction product(s) enter the return flow channel by generally following direction 416 and pass into the distal end of return conduit 410. Return conduit 410 and the return flow channel are devoid of catalyst materials, thus the catalytic conversion of reactant(s) to product(s) decreases or stops once the reactant(s) and/or reaction product(s) enter return conduit 410. The reactant(s) and/or reaction product(s) then flow back up along the return flow channel towards the proximal end of reactor 400 through return conduit 410 along direction 418 and out of reactor 400 via outlet 408 along direction 420.

With regards to the temperature gradient aspect of the reactors, reactor 400 includes distal portion 422 which operates at a temperature that is higher than the operating temperature of proximal portion 424. FIG. 4 includes an exemplary temperature profile to the right of reactor 400 showing an example of an operating temperature gradient that can be present within reactor 400 during use. Proximal portion 424 of reactor 400 is operating at a relatively low temperature (~100° C.), but the operating temperature of internal reaction volume 404 steadily increases along the length of reactor 400, with distal portion 422 of reactor 400 operating at a relatively high temperature (~1,000° C.). The temperature profile shown in FIG. 4 is for illustration purposes only, and the actual temperature gradients within the reactors can vary from those shown in FIG. 4. The operating temperature gradients within the reactors can be a function of heat generated or consumed by a reaction occurring in internal reaction volume 404, heat transferred between the fluids flowing through various parts of reactor 400, and any heat added or removed from reactor 400 via a heating or cooling element.

With regards to the transfer of heat between fluid flowing within reactor 400, the fluid flowing through the return flow channel acts as a heat source for the fluids flowing through the internal reaction volume 404. As fluid flows through return conduit 410 from the distal end to the proximal end of reactor 400, the fluid transfers heat to the walls of return conduit 410 and return conduit 410, in turn, conducts that heat energy to the fluid in internal reaction volume 404. While reactor 400 does not illustrate baffles or catalyst materials, if an inventive reactor includes those features the return conduit(s) will also conduct heat into the baffles and catalyst material and the baffles and that heat will in turn be transferred to the fluid that contacts the baffles and/or catalyst material. In this way, the reactors provide for a continuous heat transfer process, with relatively hot fluid in the return conduit(s) transferring heat to the cooler fluid in the internal reaction volume on the opposite side of the return conduit wall. For example, when reactant fluid first enters reactor 400, it is warmed by heat transferred out of the proximal portion of return conduit 410. As that heated reactant fluid continues its journey through internal reaction volume 404 and distally down the length of reactor 400, the reactant fluid is continuously heated by heat transferred out of return conduit 410. When the reactant fluid reaches the distal end of internal reaction volume 404 at the distal portion 422 of reactor 400, the reactant fluid, and any product fluid that has been created in the internal reaction volume 404, will be at or near its highest process operating temperature. The hot reactant and product fluid will then travel back towards proximal portion 424 of reactor 400 through return conduit 410, and, as it does, the fluid will transfer its heat to the inner walls of return conduit 410. When the reactant and product fluid reach the proximal end of return conduit 410, the fluid has cooled considerably due to the continual transfer of heat to return conduit 410 and into internal reaction volume 404 as the fluid travelled along the length of return conduit 410.

With regards to heat added or removed from reactor 400, various parts of reactor 400 may be heated or cooled. For example, distal portion 422 and/or proximal portion 424 of reactor 400 may be supplied with heat from an internal or external heat source to add heat and/or increase the temperature of the fluids in internal reaction volume 404 of reactor 400. In another example distal portion 422 and/or proximal portion 424 of reactor 400 may be chilled to remove heat and/or reduce the temperature of fluids in reactor 400.

While return conduit 410 is devoid of catalyst materials, in some embodiments the reactors include catalyst materials positioned within a distal portion of a return conduit. The fluids entering the distal portion of a return conduit are generally going to be at or near a maximum process temperature. That is, the fluids in the distal portion of the return conduit are generally at the hottest temperature they will obtain while travelling through an inventive reactor. By including a catalyst material within the hottest distal portion of a return conduit, the heat energy of the reactants can be utilized to drive even further conversion of reactant(s) to product(s). Further, including catalyst materials within a distal portion of a return conduit can increase turbulent flow within the fluids, thereby increasing heat exchange between the fluids and the solid surfaces of the return conduit and/or catalyst materials.

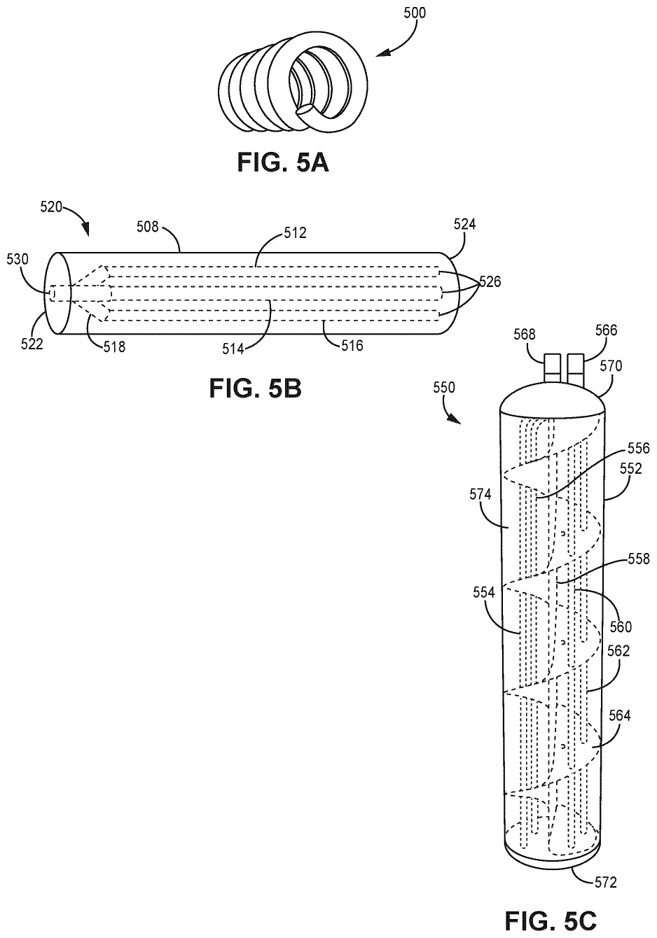

FIG. 5A illustrates a perspective view of return conduit 500 having a single helix or spiral configuration, according to some embodiments. The “internal reaction volume” of an inventive reactor that includes return conduit 500 would include not only the space or volume between the inner walls of the encasement and the outer helical radius of return conduit 500, but also the space or volume within the inner helical radius of return conduit 500 (i.e., the volume that extends along the central axis of return conduit 500 and is bounded by the inner circumferences of the helical spiral). Catalyst material can be packed both around and within the helical structure of return conduit 500. The relatively long, winding return flow path defined by return conduit 500 can provide an adequate amount of heat transfer between the fluids within return conduit 500 and the fluid within an internal reaction volume without the use of baffles extending from the outer surface of return conduit 500.

FIG. 5B illustrates a simplified side view of reactor 520 of the present invention that includes multiple return conduits (return conduits shown in phantom), according to some embodiments. For simplicity, FIG. 5B omits a number of elements found in reactors of the present invention and illustrates encasement 508 as partially transparent so as to better illustrate the return conduit structure within reactor 520.

Reactor 520 includes encasement 508, first return conduit 512, second return conduit 514, third return conduit 516, and return manifold 518. First, second, and third return conduits 512, 514, 516 extend along most of the length of internal reaction volume 574 of encasement 508, generally parallel to one another. Distal ends 526 of first, second, and third return conduits 512, 514, 516 are positioned in a distal portion of reactor 520 near distal end 524 of encasement 508. The proximal ends of first, second and third return conduits 512, 514, 516 are all secured to return manifold 518, and return manifold is in turn secured to proximal end 522 of encasement 508. In operation, fluid flows from an inlet in proximal end 522 (inlet not shown in FIG. 5B), down the length of encasement 508 and through internal reaction volume 574 defined by the inner walls of encasement 508 the outer walls of return conduits 512, 514, 516. The fluid then enters distal ends 526 of first, second, and third return conduits 512, 514, 516. From there, the fluid travels back up first, second, and third return conduits 512, 514, 516, flows into return manifold 518, and out of reactor 520 via outlet 530 attached to a proximal end of return manifold 518.

FIG. 5C illustrates a simplified side view of reactor 550 of the present invention that also includes multiple return conduits, according to some embodiments. For simplicity, FIG. 5C omits catalyst materials and illustrates certain structures within encasement 552 in phantom (e.g., first, second, third, fourth, and fifth return conduits 554, 556, 558, 560, and 562 and baffle 564) to better illustrate the return conduit structure within reactor 550.

Reactor 550 includes encasement 552, first return conduit 554, second return conduit 556, third return conduit 558, fourth return conduit 560, fifth return conduit 562, baffle 564, inlet 566, and outlet 568. First, second, third, fourth, and fifth return conduits 554, 556, 558, 560, 562 extend along most of the length of internal reaction volume 574 of encasement 552, generally parallel to one another. The distal ends of first, second, third, fourth, and fifth return conduits 554, 556, 558, 560, 562 are positioned in a distal portion of encasement 552 near distal end 572 of encasement 552. The proximal ends of first, second, third, fourth, and fifth return conduits 554, 556, 558, 560, 562 are all secured to a return manifold (not visible in FIG. 5C) which is in turn secured to outlet 568. Outlet 568 and inlet 566 extend through proximal end 570 of encasement 552. Third return conduit 558 is positioned roughly along the central axis of encasement 552. Helical baffle 564 projects radially off of and winds about third return conduit 558, extending along the longitudinal length of encasement 552 from proximal end 570 to distal end 572. First, second, fourth, and fifth return conduits 554, 556, 560, 562 are positioned symmetrically around third return conduit 558 and also extend longitudinally along the length of encasement 552 from proximal end 570 to distal end 572.

In operation, fluid reactant(s) enters reactor 550 via inlet 566 and flows from proximal end 570, down the length of encasement 552 and internal reaction volume 574 defined by the inner walls of encasement 552 and the outer walls of first, second, third, fourth, and fifth return conduits 554, 556, 558, 560, 562. Once the fluid reactant(s) and the formed product(s) reach distal end 572, the fluids enter the distal ends of first, second, third, fourth, and fifth return conduits 554, 556, 558, 560, 562. From there, the fluid travels back up first, second, third, fourth, and fifth return conduits 554, 556, 558, 560, 562, and flows into the return manifold and out of reactor 550 via outlet 568 extending through proximal end 570.

Because reactor 520 and reactor 550 use more than one return conduit channel, each of their respective return conduits can have a smaller diameter as compared to a reactor that utilizes only a single conduit. Further, the spacing between each of the plurality of return conduits allows the fluids in internal reaction volume 574 to surround each of the conduits. The smaller return conduit diameters and the spaced apart nature of the plurality of conduits facilitate more efficient heat transfer from the fluid within each return conduit to the fluid in internal reaction volume 574.

While reactor 520 is illustrated with three branched return conduits and reactor 550 is illustrated with five branched return conduits, some embodiments of the reactors include 2, 4, 6, 7, 8, 9, 10, or more than 10 return conduits. Further, while reactor 520 illustrates return conduits 512, 514, 516 all merging into return manifold 518, some embodiments of the reactors forgo the use of a return manifold entirely and simply have a plurality of outlets with each outlet joined to its own dedicated return conduit. In still further embodiments, the reactor has both branched return conduits merging into a return manifold and one or more return conduits with their own dedicated outlets.

The materials of construction used to make the reactors can be chosen based upon the demands and performance characteristics required for a given application. Some factors that should be considered in choosing materials of construction include thermal and/or mechanical stability, chemical reactivity, thermal conductivity, resistance to cracking, and cost. RWGS reaction applications are particularly demanding, as the carbon monoxide produced by the RWGS reaction tends to attack and corrode iron and nickel alloys in various temperature ranges, producing toxic products. In some embodiments, the reactors of the present invention operate with, and are made of material(s) that can withstand, internal operating temperatures (i.e., temperatures within the reactor encasement) of between about 50° C. and about 2000° C. and/or external operating temperatures (i.e., temperatures on the outer surface of the reactor encasement) of between about 50° C. and about 2,000° C. The reactor can include an internal heating element inside the reactor encasement to heat the system. The external reactor wall can be insulated and can be a pressure vessel material.

In some embodiments, the reactors or portions of the reactors are made of a metal or a metal alloy (e.g., a stainless steel alloy, such SS316, or a chromium nickel alloy, such as 800HT and/or TMA6301), a ceramic material, a ceramic composite material, or combinations thereof. Silicon carbide, silica, aluminum nitride, aluminum oxynitride, and/or alumina, for example, can be used to form some or all of the components of the reactors. Silicon carbide is a relatively strong material with advantageous thermal conductivity properties. Silicon carbide also has relatively low gas permeability and excellent chemical stability, a low thermal expansion coefficient, and is resistant to fracture and crack propagation.

In some embodiments, the reactors are made of two or more materials to better accommodate the temperature gradient that may span along the length of the reactor during use. For example, a distal portion of the reactor may operate at a relatively high temperature (e.g., 900° C.-1,600° C.) while a proximal portion of the reactor operates at a relatively low temperature (e.g., 50° C.-400° C.). The distal portions of the reactor can be formed from a material that is better able to handle the higher temperatures (e.g., a ceramic material or a ceramic composite material, such as silicon carbide), while more proximal portions may be made of materials that do not need to withstand those higher temperatures (e.g., a metal or metal alloy). For example, the inlet(s) or outlet(s) tubes of an inventive reactor may be formed of a metal or metal alloy, while the manifold and/or return conduit(s) and/or encasement may be formed of silicon carbide material, a silicon carbide composite, alumina, silica, aluminum nitride, aluminum oxynitride, or combinations thereof. In some embodiments, one or more portions of the reactors (e.g., the inlet/outlet tubes, encasement, return conduits, etc.) have a proximal end that is formed from one or more of the metals described herein, a distal end that is formed from one or more of the ceramic or ceramic composite materials described herein, and an intermediate portion therebetween that is formed from a mixture of both the metal and the ceramic material. In some embodiments, the ratio of the two materials in the intermediate portion can vary along the longitudinal length of the reactor portion. For example, an inlet tube can have a metal proximal portion and a ceramic distal portion and, between those two portions, an intermediate portion where the ratio of metal to ceramic gets larger near the distal end and smaller near the proximal end. The gradual transition from metal to ceramic along the intermediate portion can reduce the likelihood of stress fractures forming in the reactor during use and/or installation.

Manufacturing methods useful for making the various components of the reactors include machining, casting, molding, forming, joining, plating, isopressing, extruding, or additive manufacturing methods (e.g., binder jet 3D printing methods, extrusion 3D printing methods, stereolithography methods, robocasting methods, or selective laser sintering methods). Further, methods such as solid-state sintering, liquid-phase sintering, reactive melt infiltration, chemical vapor infiltration, and phenolic impregnate pyrolysis can be used to consolidate printed preforms into dense, usable parts of the reactors.

A 3D printing process can be used to print all or portions of the components of the reactors using one or more different types of materials. For example, a 3D printing process can be used to print two or more portions of a return conduit tube out of silicon carbide and then the two or more portions can be sintered together to create the finished return conduit tube. In another example, a 3D printing process can be used to print a distal portion of a return conduit out of silicon carbide and a proximal portion out of a metal alloy and then the two portions are welded or otherwise adhered together to form the complete return conduit tube. A 3D printing process that utilizes two or more materials and can vary the ratio of those materials across the dimensions of a workpiece can also be useful in creating the reactors or portions of the reactors. For example, a 3D printing process can be used to print a return conduit tube having a distal portion made of a first material (e.g., a ceramic or silicon carbide material), a proximal portion made of a second material (e.g., a metal alloy), and intermediate portions made of a mixture of the first and second materials.

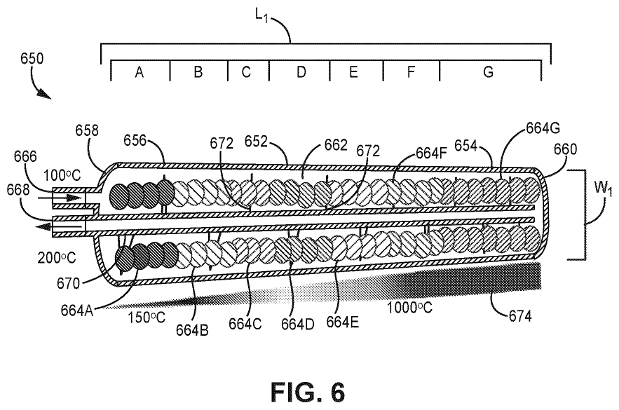

FIG. 6 illustrates a heterogeneous catalytic reactor 650, according to some embodiments. Reactor 650 includes encasement 652 which is generally cylindrical in shape, with length L₁ that is greater than its width W₁. The length L₁ of encasement 652 extends from proximal end cap 658 at one end of proximal portion 656 to distal end cap 660 at the end of distal portion 654.

Encasement 652 defines internal reaction volume 662. Encasement 652 encloses a plurality of catalyst materials 664A, 664B, 664C, 664D, 664E, 664F, and 664G within volume 662 (in the form of catalyst spheres). Catalyst materials 664A, 664B, 664C, 664D, 664E, 664F, and 664G are arranged sequentially along length L₁, with each species of catalyst materials arranged in its own catalytic zone (each of the seven catalytic zones are enumerated in FIG. 6 as lengths A, B, C, D, E, F, and G). Specifically, catalyst material 664A is arranged within catalytic zone A, catalyst material 664B are arranged within catalytic zone B, catalyst material 664C are arranged within catalytic zone C, catalyst material 664D are arranged within catalytic zone D, catalyst material 664E are arranged within catalytic zone E, catalyst material 664F are arranged within catalytic zone F, and catalyst material 664G are arranged within catalytic zone G. Each of catalysts materials 664A, 664B, 664C, 664D, 664E, 664F, and 664G are selected to optimize the performance of the reactor at the temperature and/or pressure of its respective catalytic zones A, B, C, D, E, F, and G.

Reactor 650 also includes inlet 666 and outlet 668 which both extend through proximal end cap 658, though in alternative embodiments the reactor includes more than one inlet and/or outlet (e.g., 2, 3, 4, 5, 6, 7, 8, 9, 10, or more than 10 inlets and/or outlets). Return conduit 670 is positioned within encasement 652 and extends along most of length L₁ from proximal end cap 658 towards distal end cap 660. Helical baffle 672 extends from return conduit 670 into internal reaction volume 662.

Outlet 668 and the inner walls of return conduit 670 define a return flow channel. Inlet 666 is in direct fluid communication with internal reaction volume 662 and indirect fluid communication with the return flow channel. Outlet 668 is in direct fluid communication with the portion of the return flow channel that is defined by the inner walls of return conduit 670 and indirect fluid communication with internal reaction volume 662 and inlet 666.

FIG. 6 provides temperature gradient 674, which indicates the temperature of the internal reaction volume 662 as a function of distance along length L₁ after the thermal gradient has been established (i.e., at steady state operation of reactor 650). As shown, proximal portion 656 of encasement 652 operates at a temperature of about 150° C. while distal portion 654 of encasement 652 operates at a temperature of about 1,000° C. Establishing a thermal gradient can include directing a heated fluid through inlet 666, heating or cooling distal portion 654, and/or allowing heat generated or consumed by reaction(s) occurring in internal reaction volume 662 to continue until the temperature gradient within encasement 652 comes to an equilibrium.

The exact type and quantity of reactants will vary with a given application. However, in some embodiments, the reactants include one or more of hydrogen, methane, carbon dioxide, and water. In some embodiments of the invention, fluidic carbon dioxide and hydrogen at a temperature of about 100° C. are directed through inlet 666 and into contact with catalytic material 664A positioned within catalytic zone A in internal reaction volume 662. Once in contact with catalytic material 664A, at least some of the reactants are converted to the reaction products. The exact type and quantity of resulting reaction products will also vary with a given application. However, in some embodiments, the reaction products can include one or more of carbon monoxide, water, and hydrogen.

Baffle 672 heats and promotes turbulent flow within the fluidic reactants as they traverse through internal reaction volume 662 along length L₁ of encasement 652. Further, reactants contact the other species of catalyst material 664B, 664C, 664D, 664E, 664F, and 664G positioned in their respective catalytic zones B, C, D, E, F, and G. Hence, as the fluidic reactants progress along length L₁ of encasement 652, the temperature of the reactants and catalyst materials increases and the reactants continue to contact catalytic species that further convert reactants to reaction product fluids (e.g., carbon monoxide, water, hydrogen, etc.).

Return conduit 670 defines a portion of the return flow channel which provides a flow path for the reaction products (and unreacted reactants) to leave reactor 650. As the fluidic reaction products traverse length L₁ of encasement 652 via return conduit 670, the fluidic reaction products transfer heat to return conduit 670 and that heat is in turn transferred to baffle 672 and the fluid within internal reaction volume 662. In the case of reactor 650, the fluidic reaction products flow through outlet 668 to leave reactor 650.

As shown by temperature gradient 674, the fluidic reactants and reaction products increase in temperature as they traverse distally along length L₁ within reactor 650 and its internal reaction volume 662. At proximal end cap 658, the temperature of the reactants and products are relatively low, with the reactants entering inlet 666 at a temperature of about 100° C. and gradually increase to a temperature equal to or greater than 1,000° C. once the reactant fluid reaches distal end cap 660. The product fluids (and any unreacted reactant fluids) then enter the distal end of internal reaction volume 662 at a temperature equal to or greater than 1,000° C. but decrease in temperature as they traverse proximally back along length L₁ through the length of return conduit 670. By the time the product fluids (and any unreacted reactant fluids) reach outlet 668, they have been cooled to a temperature of about 200° C. In this way, the proximal portion 656 of reactor 650 operates at a significantly lower temperature than distal portion 654.

The catalysts of the present disclosure may be used in the reactors of the present disclosure. Importantly, the catalysts may be utilized in a RWGS reactor in one or more regions/zones of the reactor where the temperature of the reaction is susceptible to methanation and coking. For example, the catalysts may be utilized in one or more regions of the reactor where the temperature of the reaction ranges from about 400° C. to about 2000° C., about 500° C. to about 900° C., or about 600° C. to about 800° C. The catalysts may be utilized in one or more regions of the reactor where the temperature of the reaction is above 400° C. These temperatures would normally cause substantial methanation in the RWGS reaction with conventional catalysts. Further, the catalysts of the present disclosure are coke-resistant, such that these catalysts are sufficient for long run times on stream. Since the catalysts include a high selectivity for carbon monoxide formation, such as greater than 95% selectivity for carbon monoxide formation, these catalysts may be sufficient for long run times and high conversions in the RWGS reaction. This efficiency may increase unit run time without the need for changing catalyst materials, decreasing operating costs. Further, since the catalysts are inert or substantially inert to methanation, less downstream purification is required after the RWGS reaction.

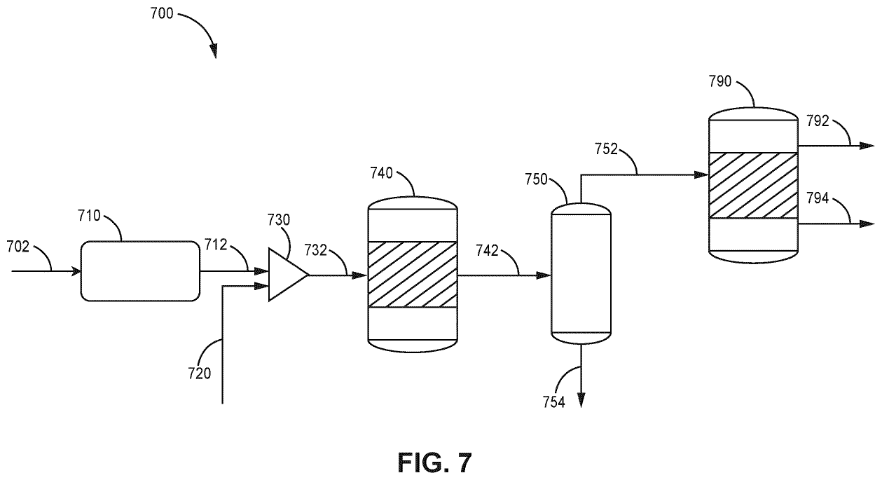

Embodiments of the present disclosure provide systems and methods for converting carbon dioxide and water to valuable liquid fuels and other chemicals. For example, the present disclosure provides systems and methods for converting carbon dioxide and water to n-paraffins, isoparaffins, and/or naphthenes. These systems may be used for production of chemicals, higher alcohols, and the like. FIG. 7 illustrates fuel production system 700, according to some embodiments. Fuel production system 700 includes electrolysis unit 710, first mixer 730, reverse-water gas shift unit 740, water separations unit 750, and hydrocarbon synthesis unit 790. Fuel production system 700 is capable of converting water and carbon dioxide to liquid fuels, such as hydrocarbons. These liquid fuels can include gasoline, diesel, and jet fuels. Accordingly, liquid transportation hydrocarbon fuels and other chemical products can be produced.

Electrolysis unit 710 is capable of receiving water feed stream 702 and producing hydrogen product stream 712. Electrolysis unit 710 includes an electrolyzer for using electricity to split water into hydrogen and oxygen. Electrolysis unit 710 may include an inlet for receiving water feed stream 702 and an outlet for hydrogen product stream 712. The electricity provided to electrolysis unit 710 is sufficient to provide energy for the electrolysis of water, and electricity may be provided at least partially, or entirely, from renewable energy sources, such as wind power. In one example, the electrolysis of water follows the formula: 2H₂O (l)→2H₂ (g)+O₂ (g). Accordingly, electrolysis unit 710 may include two electrodes or plates configured to be contacted with water in water feed stream 702. Electrolysis unit 710 may further include electrolytes and/or electrocatalysts. Water feed stream 702 may include water from various sources, such as pure water, purified seawater, and water from other processes. Water feed stream 702 may also include at least a portion of water from water product stream 754. Electrolysis unit 710 may include an alkaline electrolyzer, solid oxide electrolyzer, or a proton exchange membrane (PEM) electrolyzer. In one non-limiting example, electrolysis unit 710 includes a proton exchange membrane (PEM) electrolyzer. The hydrogen may be fed from a blue-hydrogen source.

Hydrogen product stream 712 includes hydrogen gas and optionally other trace elements or compounds. Hydrogen product stream 712 may include hydrogen at a pressure sufficient for downstream utilization without additional compression. In one non-limiting example, where electrolysis unit 710 includes a PEM electrolyzer, hydrogen is produced at a pressure sufficient for downstream utilization without further compression. Alternatively, hydrogen product stream 712 may be compressed prior to being transferred to first mixer 730. In one example, hydrogen product stream 712 may be at a pressure above about 5 bar, above about 10 bar, above about 15 bar, and/or above about 20 bar.

First mixer 730 is capable of mixing hydrogen product stream 712 with carbon dioxide reactant stream 720 sufficient to form mixed reactant stream 732. First mixer 730 may include inlets for receiving hydrogen product stream 712 and carbon dioxide reactant stream 720, and an outlet for mixed reactant stream 732. In one example, first mixer 730 is disposed downstream of and in fluid communication with electrolysis unit 710. First mixer 730 may be in direct fluid communication with electrolysis unit 710. Carbon dioxide reactant stream 720 includes carbon dioxide gas and optionally other trace elements or compounds. Carbon dioxide gas in carbon dioxide reactant stream 720 may be captured from industrial emissions or the air. Carbon dioxide reactant stream 720 may include compressed carbon dioxide at various pressures. In one example, carbon dioxide reactant stream 720 may be at a pressure above about 5 bar, above about 10 bar, above about 15 bar, and/or above about 20 bar. For example, carbon dioxide reactant stream 720 may be at a pressure above about 20 bar at about −6° C. Carbon dioxide and hydrogen may be mixed in first mixer 730 at a 1:1 ratio or any other suitable composition to form mixed reactant stream 732. In one example, the ratio of hydrogen to carbon dioxide is 2:1. Accordingly, mixed reactant stream 732 includes hydrogen and carbon dioxide.

Reverse-water gas shift unit 740 includes a reverse-water gas shift reactor vessel and is capable of producing reverse-water gas shift product stream 742. The reactor vessel may include at least one inlet for receiving mixed reactant stream 732, and at least one outlet for the reverse-water gas shift product stream 742. In one example, reverse-water gas shift unit 740 is disposed downstream of and in fluid communication with first mixer 730. Reverse-water gas shift unit 740 may be in direct fluid communication with first mixer 730. The feed to reverse-water gas shift unit 740 may include mixed reactant stream 732. Reverse-water gas shift unit 740 is capable of performing the reverse-water gas shift reaction with a catalyst, and reverse-water gas shift unit 740 may utilize the cerium-containing catalyst of the present disclosure. Accordingly, reverse-water gas shift product stream 742 includes carbon monoxide and water. The reverse-water gas shift product stream 742 may include carbon monoxide, water, and hydrogen. The ratio of hydrogen to carbon monoxide may be greater than greater than 1.5, greater than 1.7, greater than 1.8, or greater than 1.9. The ratio of hydrogen to carbon monoxide may be 2. These high ratios can be useful for further conversion into liquid fuels, chemicals, and power. Since reverse-water gas shift unit 740 and the catalyst are capable of producing richer syngas with higher hydrogen to carbon monoxide ratios, capital and operating costs of downstream processes can be reduced. Since the reverse-water gas shift reaction is endothermic, excess heat from other portions of the system may be utilized to supply heat to reverse-water gas shift unit 740.

Mixed reactant stream 732 may be fed to reverse-water gas shift unit 740 at temperatures ranging from about 10° C. to about 40° C. Therefore, reverse-water gas shift unit 740 may include an internal heating unit and/or internal heat exchanger. Mixed reactant stream 732 may be preheated prior to contacting a catalyst within reverse-water gas shift unit 740. Mixed reactant stream 732 may include pressurized gases at a pressure above 1 bar. In one example, mixed reactant stream 732 includes pressurized gases at a pressure ranging from about 1 bar to about 30 bar. In another example, mixed reactant stream 732 includes pressurized gases at a pressure above about 5 bar, above about 10 bar, or above about 15 bar.

Reverse-water gas shift unit 740 may be operated at various temperatures and pressures, such as temperatures and pressures of the present disclosure. In one example, reverse-water gas shift unit 740 is operated at temperatures above about 400° C. In another example, reverse-water gas shift unit 740 is operated at temperatures ranging from about 500° C. to about 2000° C. In one example, reverse-water gas shift unit is operated at temperatures above about 400° C., above about 500° C., above about 700° C., or above about 900° C. In one example, reverse-water gas shift unit 740 is operated at a pressure ranging from about 1 bar to about 40 bar. In another example, reverse-water gas shift unit 740 is operated at a pressure ranging from about 5 bar to about 40 bar. In yet another example, reverse-water gas shift unit 740 is operated at a pressure ranging from about 10 bar to about 30 bar. In yet another example, reverse-water gas shift unit 740 is operated at a pressure above about 15 bar, above about 20 bar, above about 25 bar, or above about 30 bar.

Reverse-water gas shift product stream 742 may be transferred to water separations unit 750 at a pressure ranging from about 1 bar to about 40 bar. In one example, reverse-water gas shift product stream 742 is transferred to water separations unit 750 at a pressure ranging from about 5 bar to about 40 bar. In another example, reverse-water gas shift product stream 742 is transferred to water separations unit 750 at a pressure ranging from about 10 bar to about 30 bar. In yet another example, reverse-water gas shift product stream 742 is transferred to water separations unit 750 at a pressure above about 15 bar, above about 20 bar, above about 25 bar, or above about 30 bar.

Water separations unit 750 is capable of at least partially separating water from reverse-water gas shift product stream 742 sufficient to produce water product stream 754 and refined syngas stream 752. In one example, water separations unit 750 is downstream of and in fluid communication with reverse-water gas shift unit 740. In another example, water separations unit 750 is in direct fluid communication with reverse-water gas shift unit 740. Therefore, the concentration of water in water product stream 754 is generally greater than the concentration of water in reverse-water gas shift product stream 742. Water separations unit 750 may be sufficient to perform phase changes. Refined syngas stream 752 includes one or more of carbon monoxide and hydrogen. Water separations unit 750 may include a vessel with an inlet for receiving reverse-water gas shift product stream 742 and outlets for water product stream 754 and refined syngas stream 752.

In one example, the operating temperature of water separations unit 750 ranges from about 25° C. to about 99° C. In another example, the operating temperature of water separations unit 750 ranges from about 30° C. to about 90° C. In yet another example, the operating temperature of water separations unit 750 is below about 85° C., below about 80° C., or below about 78° C. The operating pressure of water separations unit 750 may range from about 1 bar to about 25 bar. In one example, the operating pressure of water separations unit 750 ranges from about 1 bar to about 10 bar.

Hydrocarbon synthesis unit 790 is capable of producing first product stream 792 and second product stream 794. Hydrocarbon synthesis unit 790 is capable of receiving refined syngas stream 752. Hydrocarbon synthesis unit 790 can be downstream of and in fluid communication with water separations unit 750. Hydrogen, such as hydrogen from hydrogen product stream 712, may be mixed with refined syngas stream 752. Hydrocarbon synthesis unit 790 includes a vessel or conduit for performing a hydrocarbon synthesis reaction. First product stream 792 may include a hydrocarbon synthesis product stream. First product stream 792 may be separated (such as with flashes) to form a wax stream, a diesel stream, kerosene stream, gasoline stream, water stream, and/or naphtha stream. First product stream 792 may also include heavy tail gases (such as methane) that may be separated from other components and can be recycled to portions of fuel production system 700 or other processes. Second product stream 794 may include light gases (may be referred to as tail gas) such as H₂, CO, and/or CO₂. These light gases can be recycled back to hydrocarbon synthesis unit 790 or other portions of fuel production system 700. In one example, hydrocarbon synthesis unit 790 includes a Fischer-Tropsch (FT) unit capable of performing the Fischer-Tropsch reaction.

The Fischer-Tropsch reaction is a catalytic chemical reaction for converting carbon monoxide and hydrogen into hydrocarbons of various molecular weights. Depending on the catalyst and the temperature, differing molecular weight hydrocarbons may be produced. An example equation for a reaction in the Fischer-Tropsch process is shown below as Equation 4, where n=1 or more. Another example reaction in the Fischer-Tropsch process may be the water gas shift reaction, shown as Equation 5.

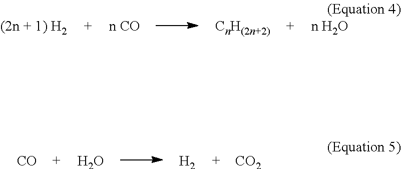

The Fischer-Tropsch reaction is highly exothermic. This process may include one or more of reactors, separations units, compressors, heat exchangers, and recycle streams. Reactors utilized for the Fischer-Tropsch process may include fixed bed reactors, fluidized bed reactors, tubular fixed bed reactor, and slurry bed reactors. In one example, hydrocarbon synthesis unit 790 is operated at a temperature ranging from about 150° C. to about 500° C. and a pressure ranging from 10 bar to 60 bar. In another example, hydrocarbon synthesis unit 790 is operated at a temperature ranging from about 200° C. to about 400° C. In yet another example, hydrocarbon synthesis unit 790 is operated at a pressure ranging from 20 bar to 40 bar.

Typically, the input hydrogen and carbon monoxide must be compressed to high pressures before entering the reactor. The Fischer-Tropsch process utilizes high pressure syngas. By increasing the operating pressure in reverse-water gas shift unit 740, and maintaining selectivity of the desired products, the compression required prior to downstream processes may be decreased. In one non-limiting example, water separations unit 750 is in direct fluid communication with hydrocarbon synthesis unit 790. Further, the increased operating pressure in reverse-water gas shift unit 740 may vastly increase the thermal conductivity of the gas mixture, decreasing the required sizes of heat exchangers. The syngas produced by reverse-water gas shift unit 740 may be transferred directly to hydrocarbon synthesis unit 790.

In one example, hydrocarbon synthesis unit 790 includes a methanol synthesis reactor. Methanol production also utilizes high pressure syngas and may include one or more of reactors, separations units, compressors, heat exchangers, and recycle streams. In one example, methanol production may utilize one or more of carbon dioxide and carbon monoxide as feed stocks. Catalysts for methanol synthesis may include one or more of copper, zinc oxide, alumina, and magnesia. Methanol production may utilize a reactor such as a fixed bed reactor at high pressure. In another example, methanol production includes a reactor operated at a pressure between 40 bar and 120 bar and a pressure between 200° C. to 400° C. In another example, methanol production is a very exothermic reaction and follows the general reaction of equation 6 or equation 7 listed below. Products in the methanol production process may include methanol and water.

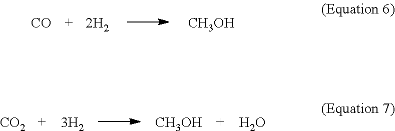

Similar to the Fischer-Tropsch process, by increasing the operating pressure in reverse-water gas shift unit 740, and maintaining selectivity of the desired products, the compression required prior to a methanol production process may be decreased. Further, the increased operating pressure in reverse-water gas shift unit 740 may vastly increase the thermal conductivity of the gas mixture, decreasing the required sizes of heat exchangers. Further, the necessary amount of coolant may be decreased between each compression cycle, and the coolant is non-recoverable energy. A ratio of H₂/CO of 2 may be desired for methanol production. Accordingly, the ratio exiting reverse-water gas shift unit 740 of the present disclosure may be closer to the desired ratio of 2 compared to a natural gas stream or other syngas streams. The syngas produced from reverse-water gas shift unit 740 of the present disclosure may be directly transferred to a methanol converter.

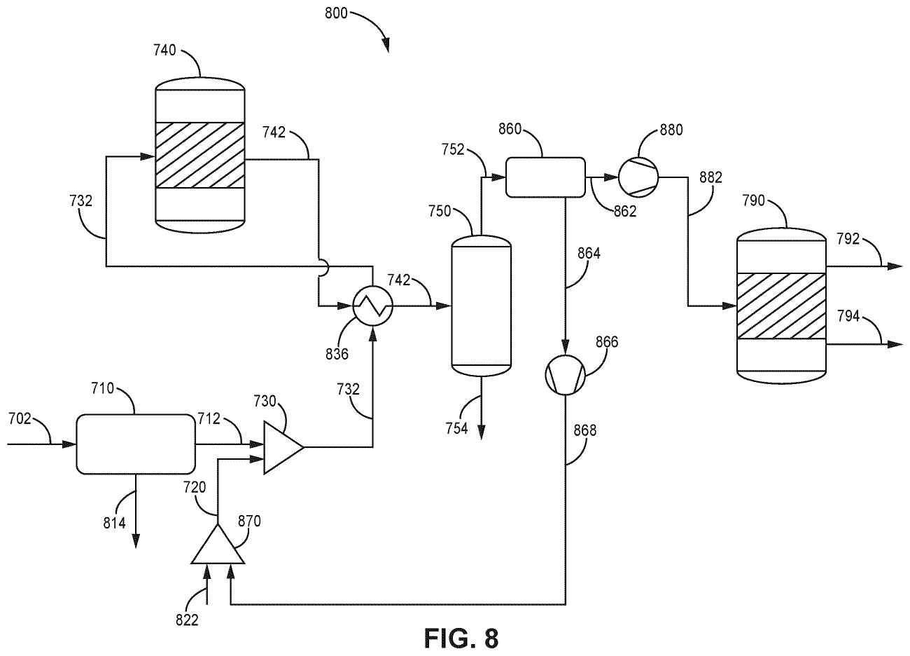

FIG. 8 illustrates fuel production system 800, according to some embodiments. These systems may be used for production of chemicals, higher alcohols, and the like. Fuel production system 800 includes electrolysis unit 710, first mixer 730, heat exchanger 836, reverse-water gas shift unit 740, water separations unit 750, carbon dioxide separations unit 860, first compressor 866, second mixer 870, second compressor 880, and hydrocarbon synthesis unit 790. As shown, electrolysis unit is capable of producing hydrogen product stream 712 and oxygen product stream 814. Oxygen product stream 814 includes oxygen gas and optionally other trace components. Oxygen product stream 814 may be utilized in various units of fuel production system 800 or other downstream processes.

Heat exchanger 836 is configured to exchange heat between mixed reactant stream 732 and reverse-water gas shift product stream 742. Exchanging heat between mixed reactant stream 732 and reverse-water gas shift product stream 742 minimizes energy waste. Therefore, heating mixed reactant stream 732 with reverse-water gas shift product stream 742 is sufficient to increase the temperature of fluids in mixed reactant stream 732 and decrease the temperature of fluids in reverse-water gas shift product stream 742. This increases the efficiency of the system since it is beneficial to cool reverse-water gas shift product stream 742 down before separating water. Heat exchanger 836 may be in fluid communication with reverse-water gas shift unit 740 and water separations unit 750.

Heat exchanger 836 and reverse-water gas shift product stream 742 may increase the temperature of fluids in mixed reactant stream 732 by over 200° C. Heat exchanger 836 may include an indirect contact heat exchanger. In one example, heat exchanger 836 and reverse-water gas shift product stream 742 may increase the temperature of fluids in mixed reactant stream 732 by over 400° C. In another example, heat exchanger 836 and reverse-water gas shift product stream 742 may increase the temperature of fluids in mixed reactant stream 732 by over 600° C. In yet another example, heat exchanger 836 and reverse-water gas shift product stream 742 may increase the temperature of fluids in mixed reactant stream 732 by over 800° C. Heat exchanger 836 may be external or internal to reverse-water gas shift unit 740. Mixed reactant stream 732 may enter heat exchanger 836 at temperatures below about 100° C., below about 60° C., or below about 30° C. Reverse-water gas shift product stream 742 may enter heat exchanger 836 prior to entering water separations unit 750.

Carbon dioxide separations unit 860 is capable of receiving refined syngas stream 752 and forming purified syngas stream 862 and carbon dioxide product stream 864. A compressor may be utilized between the carbon dioxide separations unit 860 and water separations unit 750. The compressor can compress refined syngas stream 752 according to compression requirements of carbon dioxide separations unit 860. Importantly, due to the high selectivity in the reverse-water gas shift unit 740 and the minimal methane formation (or zero methane formation), the carbon dioxide can separated from the high-quality refined syngas without potential coke formations. Further, by minimizing methane selectivity, a pure (or near pure) carbon dioxide stream can be recycled throughout the system. Refined syngas stream 752 may include at least one of carbon monoxide, carbon dioxide, and hydrogen. Carbon dioxide product stream 864 includes at least carbon dioxide. Carbon dioxide separations unit 860 may include an amine separation unit, a membrane separation unit, and/or a pressure-swing adsorption unit. Carbon dioxide separations unit can be disposed downstream of and in fluid communication with water separations unit 750. Carbon dioxide separations unit may be in direct fluid communication with water separations unit 750.

First compressor 866 includes one or more compressors, such as a mechanical compressor, for compressing carbon dioxide product stream 864 to form compressed carbon dioxide product stream 868. First compressor 866 may be in fluid communication, or direct fluid communication, with carbon dioxide separations unit 860. Carbon dioxide product stream 864 may be compressed to match pressures of carbon dioxide reactant stream 720. Second mixer 870 may receive the compressed carbon dioxide product stream 868 and carbon dioxide feed stream 822 to form carbon dioxide reactant stream 720. Accordingly, carbon dioxide product stream 864 may be recycled to be used in reverse-water gas shift unit 740, saving energy and increasing efficiency of the overall process.

Second compressor 880 includes one or more compressors, such as a mechanical compressor, for compressing purified syngas stream 862 to form compressed purified syngas stream 882. Second compressor 880 may be in fluid communication, or direct fluid communication, with carbon dioxide separations unit 860. Second compressor 880 may be fluidically connected with hydrocarbon synthesis unit 790, such as a Fischer-Tropsch unit. Accordingly, hydrocarbon synthesis unit 790 is capable of receiving compressed purified syngas stream 882. Second compressor 880 is capable of compressing purified syngas stream 862 to operating pressures of hydrocarbon synthesis unit 790. Importantly, since the reverse-water gas shift unit 740, and catalysts within, can operated at higher pressures, such as above 20 bar, less compression is required by second compressor 880.

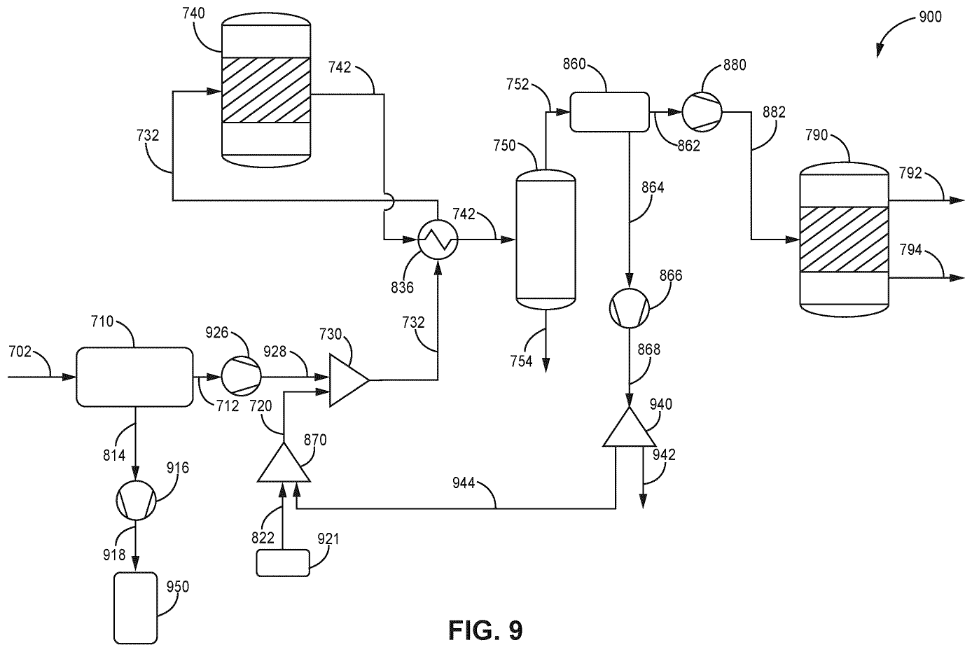

FIG. 9 illustrates fuel production system 900, according to some embodiments. These systems may be used for production of chemicals, higher alcohols, and the like. Fuel production system 900 includes electrolysis unit 710, first mixer 730, heat exchanger 836, reverse-water gas shift unit 740, water separations unit 750, carbon dioxide separations unit 860, first compressor 866, second mixer 870, second compressor 880, hydrocarbon synthesis unit 790, third compressor 926, fourth compressor 916, carbon dioxide storage tank 921, splitter 940, and downstream process 950.

Third compressor 926 is configured to compress hydrogen product stream 712 sufficient to form compressed hydrogen product stream 928. Third compressor 926 may be disposed downstream of and in fluid communication with electrolysis unit 710. Third compressor 926 may be in direct fluid communication with first mixer 730. Accordingly, first mixer 730 may be configured to receive compressed hydrogen product stream 928. Fourth compressor 916 is configured to compress oxygen product stream 814 sufficient to form compressed oxygen product stream 918. Fourth compressor 916 may be in fluid communication with electrolysis unit 710. Compressed oxygen product stream 918 may be transferred to downstream process 950. Downstream process 950 may include one or more of an oxidation of wax system, a tail gas auto-thermal reforming unit, and a tail gas reforming unit. These downstream processes may be downstream from hydrocarbon synthesis unit 790.

Carbon dioxide storage tank 921 may store carbon dioxide and may be in fluid communication with second mixer 870. Splitter 940 may be used to split compressed carbon dioxide product stream 868 into first split stream 942 and second split stream 944. Second split stream 944 may be transferred to second mixer 870. First split stream 942 may be utilized for other systems and streams in fuel production system 900. For example, first split stream 942 may be utilized for carbon capture and utilization.

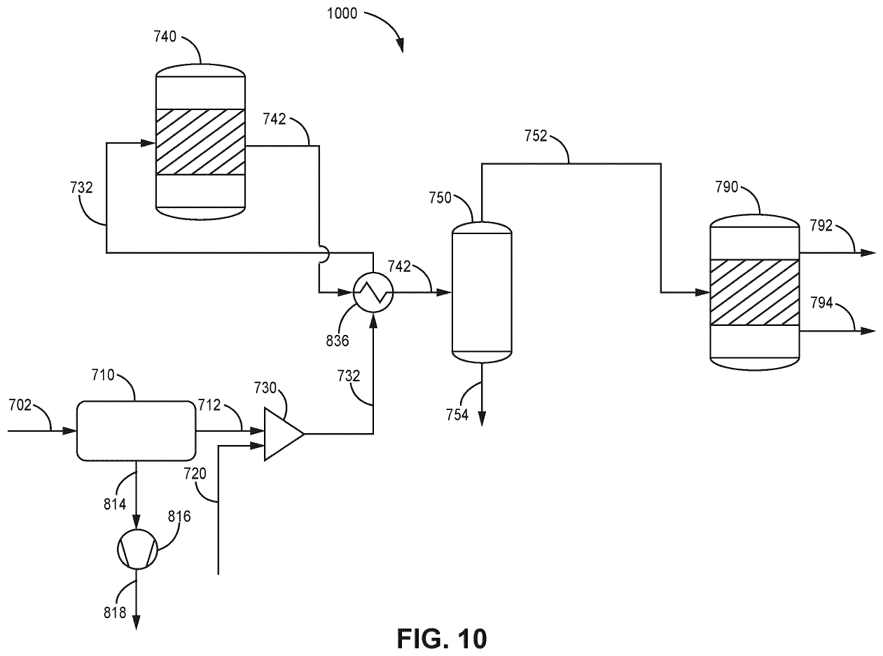

FIG. 10 illustrates fuel production system 1000, according to some embodiments. These systems may be used for production of chemicals, higher alcohols, and the like. Fuel production system 1000 includes electrolysis unit 710, first mixer 730, heat exchanger 836, reverse-water gas shift unit 740, water separations unit 750, and hydrocarbon synthesis unit 790. In one example, using catalysts, such as the cerium-containing catalyst of the present disclosure, in reverse-water gas shift unit 740 that exhibits a selectivity for carbon monoxide formation over 90% at temperatures above 400° C. and can efficiently operate at pressures over 20 bar, or over 25 bar, refined syngas stream 752 may be directly transferred to hydrocarbon synthesis unit 790. Therefore, water separations unit 750 can be in direct fluid communication with hydrocarbon synthesis unit 790. Importantly, since the reverse-water gas shift unit 740 can operate at higher pressures of the present disclosure, less (or no additional) compression is required between reverse-water gas shift unit 740 and hydrocarbon synthesis unit 790. Systems 700, 800, 900, and 1000 may be utilized to product hydrocarbon products. These systems may include conduits, such as piping, to transfer streams between units. These systems may also include valves, pumps, compressors, heat exchangers, mixers, and splitters.

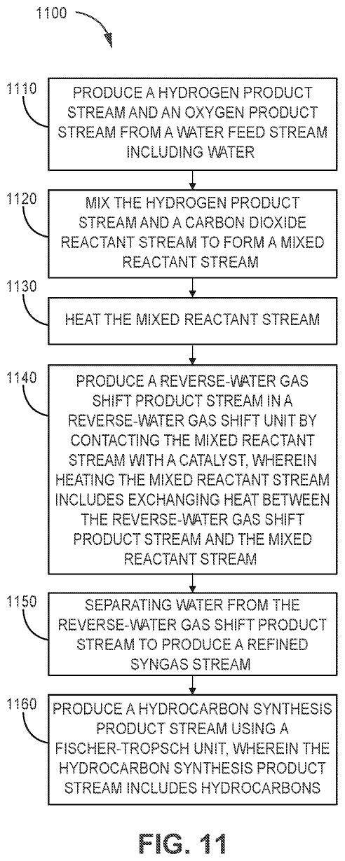

FIG. 11 illustrates method 1100 for processing a feed stock to produce liquid fuel, according to some embodiments. This method may be used for production of chemicals, higher alcohols, and the like. Method 1100 includes one or more of the following steps (with various orders possible):

At step 1110, a hydrogen product stream and an oxygen product stream are produced from a water feed stream including water. The water feed stream may be introduced from various sources. For example, the water feed stream may include water from various sources, such as pure water, purified seawater, and water from other processes. The hydrogen product stream and the oxygen product stream may be produced by an electrolyzer, such as electrolysis unit 710. As discussed, electrolysis unit 710 may include an alkaline electrolyzer, solid oxide electrolyzer, or a proton exchange membrane (PEM) electrolyzer. The hydrogen product stream includes at least hydrogen gas. The hydrogen product stream may be produced at a pressure above about 5 bar, above about 10 bar, above about 15 bar, and/or above about 20 bar.

The oxygen product stream includes at least oxygen gas. The oxygen product stream may be produced at pressures above about 1 bar, above about 5 bar, or above about 10 bar. Step 1110 may further include compressing the oxygen product stream to form a compressed oxygen product stream, and transferring the compressed oxygen product stream to a downstream process unit that does not perform any of: electrolysis, a reverse-water gas shift reaction, and a Fischer-Tropsch reaction. In one example, the compressed oxygen product stream is transferred to at least one of a wax oxidation unit, a tail gas auto-thermal reforming unit, and a tail gas reforming unit.

At step 1120, the hydrogen product stream and a carbon dioxide reactant stream are mixed to form a mixed reactant stream. In one example, the hydrogen product stream and the carbon dioxide stream are mixed/combined using a mixer, such as first mixer 730. The carbon dioxide reactant stream may include compressed carbon dioxide at various pressures. In one example, the carbon dioxide reactant stream may be introduced at a pressure above about 5 bar, above about 10 bar, above about 15 bar, and/or above about 20 bar. For example, the carbon dioxide reactant stream may be at a pressure above about 20 bar at about −6° C. The mixed reactant stream includes at least hydrogen gas and carbon dioxide gas. The mixed reactant stream may include hydrogen gas and carbon dioxide gas at various ratios, such as a 1:1 or 2:1 ratio.

At step 1130, the mixed reactant stream is heated. The mixed reactant stream may be heated using various heating units, such as heat exchangers and/or electric heating. In one example, the mixed reactant stream is heated using heat exchanger 836. In one example, the mixed reactant stream may have an initial temperature ranging from about 10° C. to about 30° C. The mixed reactant stream may be heated to at least 300° C., at least 500° C., at least 700° C., or at least 1000° C. The mixed reactant stream may be heated to at least 800° C., at least 1100° C., or at least 1500° C. The temperature of the mixed reactant stream (from initial temperature) may be increased by over 500° C., over 800° C., over 1200° C., or over 1400° C. The mixed reactant stream may be heated internal to a reverse-water gas shift unit. Alternatively, the mixed reactant stream may be heated in a heat exchanger, wherein heating is performed at least partially outside of a reverse-water gas shift unit.

At step 1140, a reverse-water gas shift product stream is produced in a reverse-water gas shift unit by contacting the mixed reactant stream with a catalyst at a temperature above about 400° C. and a pressure ranging from about 1 bar to 40 bar, wherein heating the mixed reactant stream includes exchanging heat between the reverse-water gas shift product stream and the mixed reactant stream. At step 1140, the reverse-water gas shift reaction is performed. The reverse-water gas shift product stream may be produced in a reactor, such as reverse-water gas shift unit 740.

The catalyst utilized for step 1140 includes catalysts of the present disclosure, such as the cerium-containing catalyst of the present disclosure. Accordingly, the catalyst may exhibit a selectivity for carbon monoxide formation above about 85%, above about 90%, or above about 95%. The catalyst may exhibit greater than 95% selectivity for carbon monoxide formation in a mixture of carbon dioxide and hydrogen at temperatures above about 400° C. The reverse-water gas shift product stream may be produced at temperatures above 500° C., above 700° C., or above 1000° C. In one example, the mixed reactant stream is contacted with the catalyst at a pressure ranging from 25 bar to 40 bar. In another example, the reverse-water gas shift product stream may be produced at pressures above about 10 bar, above about 15 bar, above about 20 bar, or above about 25 bar. The reverse-water gas shift product stream includes carbon monoxide and water.

At step 1150, water is separated from the reverse-water gas shift product stream to produce a refined syngas stream. Water may be separated from the reverse-water gas shift product stream using a separations unit, such as water separations unit 750. At least a portion of water in reverse-water gas shift product stream is separated from carbon monoxide. In one example, water is separated from the reverse-water gas shift product stream at temperatures ranging from about 50° C. to about 99° C. In another example, water is separated from the reverse-water gas shift product stream at temperatures ranging from about 50° C. to about 90° C. In yet another example, water is separated from the reverse-water gas shift product stream at temperatures below about 85° C., below about 80° C., or below about 78° C. Water can be separated from the reverse-water gas shift product stream at pressures ranging from about 1 bar to about 30 bar. In one example, water can be separated from the reverse-water gas shift product stream at pressures ranging from about 1 bar to about 10 bar. The concentration of carbon monoxide in the refined syngas stream can be greater than the reverse-water gas shift product stream.

At step 1160, a hydrocarbon synthesis product stream is produced using a Fischer-Tropsch unit, wherein the hydrocarbon synthesis product stream includes hydrocarbons. In addition, or alternatively, step 1160 may include producing a hydrocarbon synthesis product stream using a methanol reactor. At least a portion of the refined syngas stream may be transferred to the Fischer-Tropsch unit without further compression. A hydrocarbon synthesis product stream may be produced in a hydrocarbon synthesis unit, such as hydrocarbon synthesis unit 790. The hydrocarbon synthesis product stream may be produced at temperatures and pressures discussed above for hydrocarbon synthesis unit 790. The hydrocarbon synthesis product stream may include various hydrocarbons. Accordingly, method 1100 may be used to produce n-paraffins, isoparaffins, and/or naphthenes.

Method 1100 may further comprise separating carbon dioxide from the refined syngas stream to form a purified syngas stream and a carbon dioxide product stream. Carbon dioxide may be separated in a separations unit, such as carbon dioxide separations unit 860. The purified syngas stream may be compressed to form a compressed purified syngas stream. The compressed purified syngas may be transferred to the Fischer-Tropsch unit. Method 1100 may further comprise compressing the carbon dioxide product stream sufficient to form a compressed carbon dioxide product stream. The compressed carbon dioxide product stream may be recycled. The compressed carbon dioxide product stream can be mixed with a carbon dioxide feed stream to form the carbon dioxide reactant stream. Accordingly, the compressed carbon dioxide product stream can be recycled to feed the reverse-water gas shift step in step 1140.

Importantly, systems and methods for liquid fuel production of the present disclosure can efficiently produce liquids fuels using carbon dioxide and water. Due to the operating conditions and selectivity in the reverse-water gas shift reactors, a higher-purity reverse-water gas shift product stream can be produced. Accordingly, equipment capital and operating costs can be reduced. Further, carbon dioxide can be recycled to various portions of the process to reduce the total amount of carbon dioxide fed to the system.

### Example 1

Catalysts were prepared with a 20 wt. % loading on 2.5 mm diameter high-purity alumina beads using the incipient wetness technique. For each formulation including cerium, zirconium, and praseodymium, cerium nitrate hexahydrate, zirconium oxynitrate hydrate, and praseodymium nitrate hexahydrate were prepared as an aqueous solution, then used to impregnate the beads. The beads were dried at 110° C. for 12 hours, and calcined for 1 hour at 300° C. and 2 hours at 900° C. Crushed catalyst beads were used for most testing.

In one example, cerium, zirconium, and praseodymium nitrates were combined in specific amounts sufficient to have a final catalyst with 80 mol % Ce, 17.5 mol % Zr, and 2.5 mol % Pr in the composition of the catalyst. Nitrate salts as precursors were dissolved into distilled water followed by sonication and impregnation using a magnetic stirrer. For example, the total of 3.0346 grams of combined salts were solved into 7.5 mL of distilled water and 10 grams of alpha alumina beads were added to the solution at a constant temperature of 40° C. The transfer of catalytic materials into the pores of the alumina support was obtained in aqueous form by controlled stirring. The mixed solution of catalytic materials and alumina support was dried in an oven for about 20 hours overnight. The calcination process was done in a tube furnace at atmospheric pressure, wherein the metal salts are decomposed to oxide. The calcination was completed at 300° C. for one hour and 600° C. for two hours. The catalysts were then slowly cooled down to room temperature inside the furnace. The amount of catalyst in the alumina beads (specific surface area=<12 m²/g, 0.1% SiO₂, and a median pore diameter of 0.2 micron) was 10% of the weight of the beads. In one example, the final composition of the catalyst includes 80 mol % Ce, 17.5 mol % Zr, and 2.5 mol % Pr.

For catalyst testing experiments, the ratio of H₂/CO₂ was 2. The gas flow rates for the RWGS reaction were set at 6 mL/min for H₂ and 3 mL/min for CO₂. Catalysts of the present disclosure were tested in metal alloy reactors of tubular shape. A Ni catalyst was used as a comparison, and this catalyst was tested in an alumina ceramic tube with 0.75 inch (19.05 mm) ID. The catalysts of the present disclosure displayed better performance compared to Ni and were compared for selectivity data.

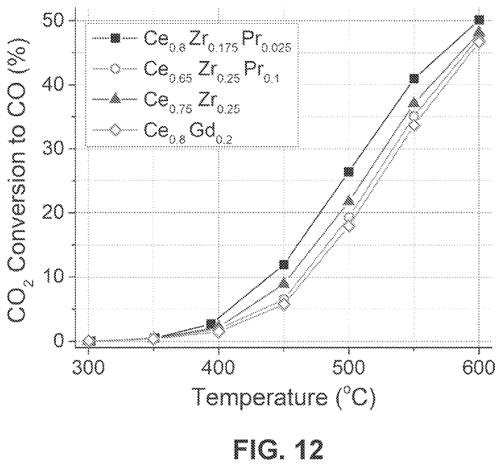

FIG. 12 illustrates a comparison of reverse-water gas shift (RWGS) CO₂ conversions of various catalysts at different temperatures, according to some embodiments. The catalysts were impregnated on an alpha-phase alumina support. Input CO₂/H₂ ratio was 2.0, and the CO₂ conversion to CO using equation of output gasses CO %/(CO₂%+CO %+CH₄%) is shown. The catalysts include Ce_{0.8}Gd_{0.2}, Ce_{0.75}Zr_{0.25}, Ce_{0.65}Zr_{0.25}Pr_{0.1}, and Ce_{0.8}Zr_{0.175}Pr_{0.025} oxides. As the temperature varied from 300° C. to 600° C., the CO₂ conversion to CO increased with a positive correlation. As shown, the Ce_{0.8}Zr_{0.175}Pr_{0.025} catalyst provided the highest CO₂ conversion to CO at all temperatures evaluated. For example, at 600° C., the CO₂ conversion to CO for the Ce_{0.8}Zr_{0.175}Pr_{0.025} catalyst was about 50%.

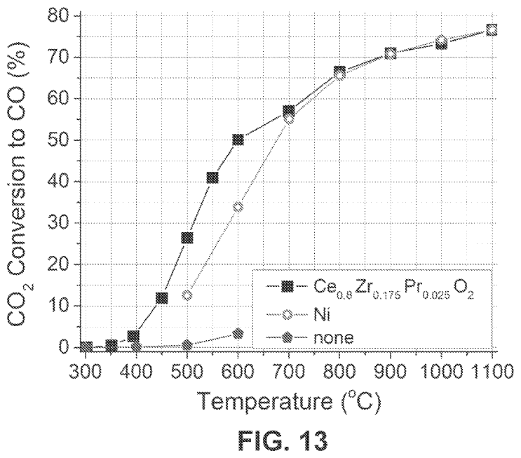

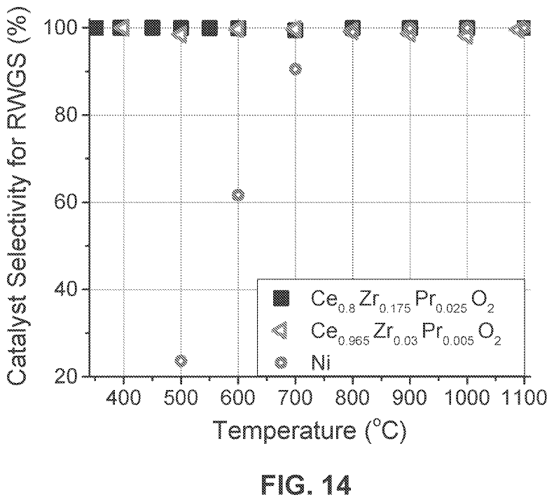

FIG. 13 illustrates a comparison of RWGS CO₂ conversions of various catalysts and no catalyst, according to some embodiments. Both catalysts are on alpha-phase alumina support. The input CO₂/H₂ ratio is 2.0, and the CO₂ conversion to CO using equation of output gasses CO %/(CO₂%+CO %+CH₄%) is shown. FIG. 14 illustrates the catalyst selectivity for the RWGS reaction of various catalysts, according to some embodiments. Catalysts are on alpha-phase alumina support. The input CO₂/H₂ ratio is 2.0, and the selectivity is based on equation of output gasses CO %/(CO %+CH₄%). The catalysts include Ce_{0.8}Zr_{0.175}Pr_{0.025}O₂, Ce_{0.965}Zr_{0.03}Pr_{0.005}O₂, and Ni. As shown, the Ce_{0.8}Zr_{0.175}Pr_{0.025}O₂ and Ce_{0.965}Zr_{0.03}Pr_{0.005}O₂ selectivity for the RWGS reaction was greater than about 98% and greater than about 99% at temperatures between 350° C. and 900° C. Importantly, the Ce_{0.8}Zr_{0.175}Pr_{0.025}O₂ and Ce_{0.965}Zr_{0.03}Pr_{0.005}O₂ selectivity for the RWGS reaction was high even at lower temperatures, such as below 700° C. The Ni catalyst included lower selectivity before the temperature reached about 800° C.

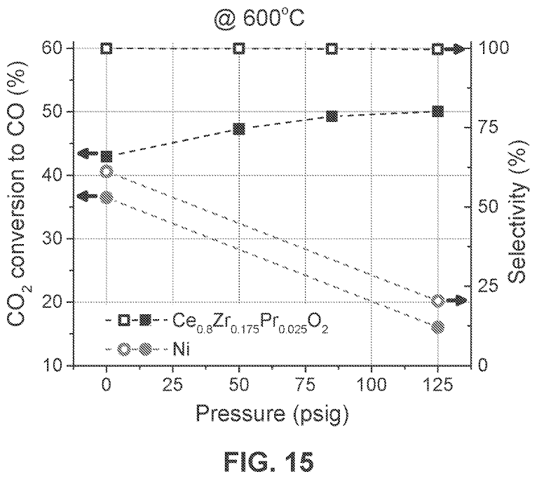

FIG. 15 illustrates conversion of CO₂ and catalyst selectivity for the RWGS reaction for various catalysts as a function of pressure, according to some embodiments. Tested catalysts include a Ni catalyst and a Ce_{0.8}Zr_{0.175}Pr_{0.025}O₂ catalyst. These results for carbon dioxide conversion to carbon monoxide and catalyst selectivity for the reverse-water gas shift reaction are for 600° C. using 2:1 H₂:CO₂ gas input. As shown, the carbon dioxide conversion to carbon monoxide and the catalyst selectivity are greater for the Ce_{0.8}Zr_{0.175}Pr_{0.025}O₂ catalyst compared to the Ni catalyst. The pressures varied from about 1 bar to about 8.62 bar. Data sets with a hollow symbol are illustrating selectivity.

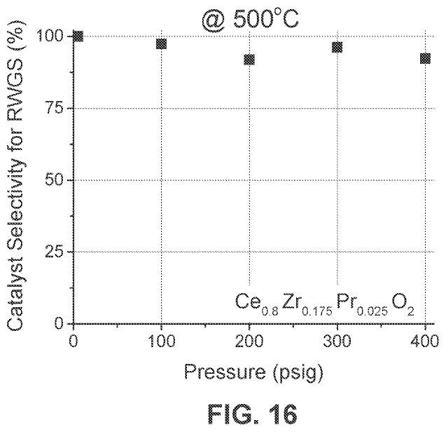

FIG. 16 illustrates catalyst selectivity for the RWGS reaction a catalyst as a function of pressure, according to some embodiments. The tested catalyst was the Ce_{0.8}Zr_{0.175}Pr_{0.025}O₂ catalyst. In one example, 500° C. is near the maximum possible methanation temperature. The catalyst was tested at a 2:1 H₂:CO₂ input ratio. Importantly, methane formation was occurring due to the stainless-steel exhaust line, not the catalyst itself. No coking was observed for the catalyst. Pressures were varied from about 1 bar to about 400 psig (~28 bar).

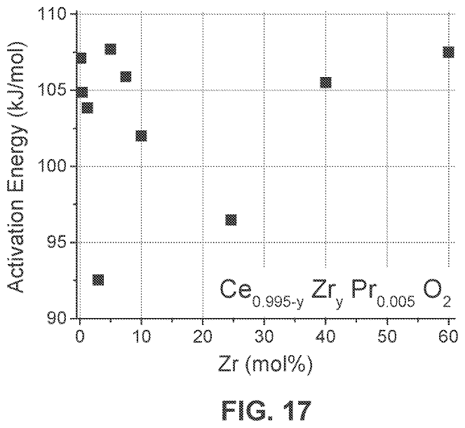

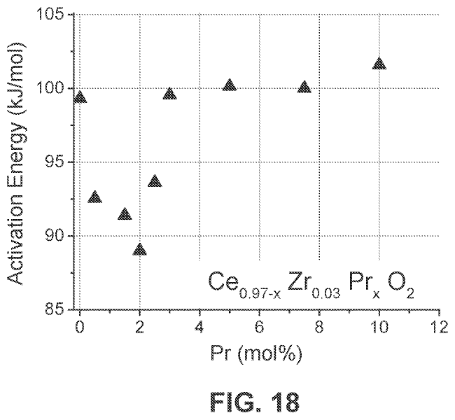

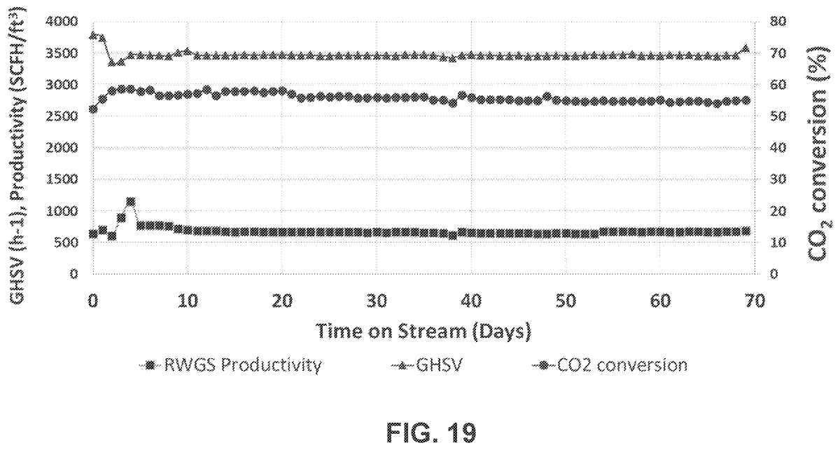

FIG. 17 illustrates activation energy as a function of zirconium mol %, according to some embodiments. These results were obtained from kinetic testing experiments using 2:1 H₂:CO₂ inputs at different temperatures. In one example, the lower activation energies correlate to higher kinetic rates. As shown in FIG. 17, the mol % of zirconium was varied to show differences in activation energy. The mol % of zirconium was varied from near 0% to 60%. FIG. 18 illustrates activation energy as a function of praseodymium mol %, according to some embodiments. These results were obtained from kinetic testing experiments using 2:1 H₂:CO₂ inputs at different temperatures. In one example, the lower activation energies mean higher kinetic rates. As shown in FIG. 18, the mol % of praseodymium was varied to show differences in activation energy. The mol % of praseodymium was varied from near 0% to 12%. FIG. 19 illustrates catalyst performance over 70 days on-stream, according to some embodiments. The temperature was held at 850° C. The input CO₂/H₂ ratio was 1.85 with flow rates of 75 standard cubic feet per hour (scfh) CO₂ and 139 scfh H₂, at a pressure of ~40 psi.

Numerous catalysts were tested for conversion and selectivity values during a reverse-water gas shift reaction. The H₂/CO₂ ratio was about 2, the gas hourly space velocity (GHSV) was about 5347 hr⁻¹, and the testing was completed at ambient pressure, such as about 1.01 bar. The tested catalysts all exhibited a selectivity to CO of over 99% at temperatures of 600° C. and 800° C. The results are shown in Table 1.

TABLE 1
Catalyst Conversions and Selectivity

| | | | | Selectivity | | Selectivity |
|---|---|---|---|---|---|---|
| | | | Conversion | (600° C.) | Conversion | (800° C.) |
| | H₂/ | GHSV | (600° C.) | selectivity | (800° C.) | selectivity |
| Composition | CO₂ | hr⁻¹ | % | to CO | % | to CO |
| Ce_{0.9873}Zr_{0.0077}Bi_{0.005}O₂ | 2 | 5347 | 24.3 | 99.8 | 63.8 | 99.75 |
| Ce_{0.9916}Nb_{0.0034}Pr_{0.005}O₂ | 2 | 5347 | 21.4 | 99.9 | 64.1 | 99.98 |
| Ce_{0.98945}Hf_{0.00555}Pr_{0.005}O₂ | 2 | 5347 | 22.8 | 99.9 | 64.0 | 99.98 |
| Ce_{0.989}Zr_{0.006}Tb_{0.005}O₂ | 2 | 5347 | 23.9 | 99.9 | 64.1 | 100 |
| Ce_{0.73}Zr_{0.2458}Pr_{0.0227}O₂ | 2 | 5347 | 18.6 | 99.8 | 64.3 | 99.85 |

### Example 2

RWGS reactor testing was completed for the background methanation caused by the reactor vessel material itself and downstream metal tubing materials. This experiment was completed without using any catalysts. The reactor was a 316 stainless steel disk reactor with a volume of 3.2 mL. The flow rates for H₂ and CO₂ were 12 mL/min and 6 mL/min, respectively. The methanation caused by the reactor is shown in Table 2. As the temperature increases from 300° C. to 600° C., the amount of methane produced also increases. The methane yield at 600° C. was ~325 ppm.

TABLE 2
Methanation caused by the Reactor.

| Temperature (° C.) | Methane (ppm) |
|---|---|
| 300 | 0 |
| 350 | 0 |
| 400 | 10 |
| 450 | 20 |
| 500 | 66 |
| 550 | 198 |
| 600 | 325 |

While the disclosure has been described with reference to an exemplary embodiment(s), it will be understood by those skilled in the art that various changes may be made, and equivalents may be substituted for elements thereof without departing from the scope of the embodiment(s). In addition, many modifications may be made to adapt a particular situation or material to the teachings of the embodiment(s) without departing from the essential scope thereof. Therefore, it is intended that the disclosure is not limited to the disclosed embodiment(s), but that the disclosure will include all embodiments falling within the scope of the appended claims. Various examples have been described. These and other examples are within the scope of the following claims.

### Discussion of Possible Embodiments

The following are non-exclusive descriptions of possible embodiments of the present invention.

According to one aspect, a catalyst includes catalytically active material including a formula: CeJQO, wherein Ce is Cerium, J includes at least one of Zirconium, Hafnium, Niobium, Tantalum, and Titanium, Q includes at least one of Praseodymium, Terbium, Thulium, Europium, Samarium, Ytterbium, Gallium, Germanium, Indium, Tin, Antimony, and Bismuth, and O is oxygen; and a support, wherein the catalyst has greater than 95% selectivity for carbon monoxide formation in a mixture of carbon dioxide and hydrogen operated at a temperature above 400° C.

The catalyst of the preceding paragraph can optionally include, additionally and/or alternatively, any one or more of the following features, configurations, and/or additional components.

For example, the support may include one or more of alumina and magnesium aluminate.

For example, the support may include one or more of aluminosilicate, zirconium oxide, silicon carbide, steatite, magnesium aluminate, cordierite, magnesium oxide, calcium oxide, potassium oxide, sodium oxide, yttrium oxide, aluminum titanate, and strontium titanate.

For example, the support may include a porous, alpha-phase alumina support bead and the catalytically active material forms a coating on substantially an entire surface area of the porous, alpha-phase alumina support bead.

For example, the catalyst may further comprise magnesium oxide in contact with a surface of the support.

For example, the catalyst can be coke-resistant and substantially inert to methanation during formation of carbon monoxide in the mixture of carbon dioxide and hydrogen.

For example, J may include at least one of Zirconium, Hafnium, and Niobium.

For example, Q may include at least one of Praseodymium, Terbium, and Bismuth.

For example, J may include Zirconium.

For example, Q may include Praseodymium.

According to another aspect, a catalyst includes catalytically-active material including a formula: CeₓJ_{y}Q_{z}O₂₋ₙ, wherein Ce is Cerium, J includes at least one of Zirconium, Hafnium, Niobium, Tantalum, and Titanium, Q includes at least one of one or more metals and one or more metalloids, and O is oxygen; and wherein x, y, and z represent component mole fractions with respect to total moles of Ce, J, and Q; and wherein x ranges from 0.4 to 0.999, y ranges from 0.001 to 0.60, z ranges from 0.001 to 0.2, and n ranges from 0 to 0.5; and a support.

The catalyst of the preceding paragraph can optionally include, additionally and/or alternatively, any one or more of the following features, configurations, and/or additional components.

For example, J may include at least one of Zirconium, Hafnium, and Niobium.

For example, J may include Zirconium.

For example, the one or more metals may be selected from Praseodymium, Terbium, Thulium, Europium, Samarium, Ytterbium, Gallium, Indium, Tin, and Bismuth.

For example, the one or more metals may include at least one of Praseodymium, Terbium, and Bismuth.

For example, the one or more metals may include Praseodymium.

For example, the one or more metalloids may be selected from Germanium and Antimony.

For example, J may include Zirconium, Q may include Praseodymium, wherein x ranges from 0.9 to 0.999, y ranges from 0.001 to 0.1, and z ranges from 0.001 to 0.05.

For example, J may include Niobium, wherein y ranges from 0.001 to 0.1.

For example, J may include Hafnium, wherein y ranges from 0.001 to 0.1.

For example, the one or more metals may include Bismuth, wherein z ranges from 0.001 to 0.05.

For example, the one or more metals may include Terbium, wherein z ranges from 0.001 to 0.05.

For example, the support may include one or more of alumina and magnesium aluminate.

For example, the catalyst may further include one or more of Chromium, Manganese, Iron, Nickel, Copper, Zinc, Molybdenum, and Silver.

For example, the catalyst may further include one or more of Beryllium, Magnesium, Calcium, Strontium, Barium, Sodium, Potassium, Rubidium, and Caesium.

For example, the catalyst may further include one or more of Yttrium, Neodymium, Promethium, Gadolinium, Dysprosium, Holmium, Erbium, and Lutetium.

According to another aspect, a method for performing a reverse-water gas shift reaction includes contacting a feed stock with a catalyst at a temperature above 400° C., sufficient to generate a reaction product, wherein the feed stock includes carbon dioxide and hydrogen, the reaction product includes carbon monoxide and water, and the catalyst includes (1) catalytically active material including a formula: CeJQO, wherein Ce is Cerium, J includes at least one of Zirconium, Hafnium, Niobium, Tantalum, and Titanium, Q includes at least one of Praseodymium, Terbium, Thulium, Europium, Samarium, Ytterbium, Gallium, Germanium, Indium, Tin, Antimony, and Bismuth, and O is oxygen, and (2) a support.

The method of the preceding paragraph can optionally include, additionally and/or alternatively, any one or more of the following steps, configurations, and/or additional components.

For example, the support may include one or more of alumina and magnesium aluminate.

For example, the support may include one or more of aluminosilicate, zirconium oxide, silicon carbide, steatite, magnesium aluminate, cordierite, magnesium oxide, calcium oxide, potassium oxide, sodium oxide, yttrium oxide, aluminum titanate, and strontium titanate.

For example, the catalyst may include magnesium oxide in contact with a surface of the support.

For example, the method may include contacting the feed stock with the catalyst at a temperature ranging from about 500° C. to about 2000° C.

For example, the method may include generating the reaction product without the catalyst substantially contributing to methane formation.

For example, the method may include generating the reaction product at a pressure between 1 bar and 40 bar.

For example, the method may include generating the reaction product in a reactor selected from an isothermal reactor, a thermal gradient reactor, a fixed-bed reactor, and a fluidized bed reactor.

For example, the catalyst can have greater than 95% selectivity for carbon monoxide formation.

For example, the catalyst can have greater than 99% selectivity for carbon monoxide formation.

For example, J may include at least one of Zirconium, Hafnium, and Niobium.

For example, Q may include at least one of Praseodymium, Terbium, and Bismuth.

For example, J may include Zirconium and Q may include Praseodymium.

According to another aspect, a system for producing hydrocarbon products includes (1) an electrolysis unit capable of receiving a water feed stream and producing a hydrogen product stream and an oxygen product stream; (2) a reverse-water gas shift unit disposed downstream of and in fluid communication with the electrolysis unit, the reverse-water gas shift unit being capable of producing a reverse-water gas shift product stream, wherein the reverse-water gas shift product stream includes carbon monoxide; (3) a water separations unit disposed downstream of and in fluid communication with the reverse-water gas shift unit, the water separations unit being capable of at least partially separating water from the reverse-water gas shift product stream sufficient to produce a water product stream and a refined syngas stream; (4) a carbon dioxide separations unit downstream of and in fluid communication with the water separations unit, wherein the carbon dioxide separations unit is capable of receiving the refined syngas stream and producing a carbon dioxide product stream and a purified syngas stream; and (5) a Fischer-Tropsch unit downstream of the water separations unit, the Fischer-Tropsch unit being capable of producing a hydrocarbon synthesis product stream, wherein the hydrocarbon synthesis product stream includes hydrocarbons.

The system of the preceding paragraph can optionally include, additionally and/or alternatively, any one or more of the following features, configurations, and/or additional components.

For example, the system may further comprise a first mixer and a heat exchanger, wherein the first mixer is capable of mixing the hydrogen product stream with a carbon dioxide reactant stream to form a mixed reactant stream, and wherein the heat exchanger is configured to exchange heat between the mixed reactant stream and the reverse-water gas shift product stream.

For example, the system may further comprise a first compressor configured to compress the carbon dioxide product stream to form a compressed carbon dioxide product stream.

For example, the system may further comprise a second mixer, wherein the second mixer mixes at least a portion of the compressed carbon dioxide product stream with a carbon dioxide feed stream sufficient to form the carbon dioxide reactant stream.

For example, the system may further comprise a splitter downstream of and in fluid communication with the first compressor, wherein the splitter is capable of splitting the compressed carbon dioxide product stream to form a first split stream and a second split stream.

For example, the system may further comprise a second compressor, wherein the second compressor is in fluid communication with the carbon dioxide separations unit, and wherein the second compressor is capable of compressing the purified syngas stream to form a compressed purified syngas stream.

For example, the second compressor may be fluidically connected with the Fischer-Tropsch unit, and wherein the Fischer-Tropsch unit is capable of receiving the compressed purified syngas stream.

For example, the reverse-water gas shift unit can include a cerium-containing catalyst.

For example, the system may further comprise a third compressor, wherein the third compressor is configured to compress the hydrogen product stream sufficient to form a compressed hydrogen product stream.

According to another aspect, a method for processing a feed stock to produce liquid fuel includes producing a hydrogen product stream and an oxygen product stream from a water feed stream including water; mixing the hydrogen product stream and a carbon dioxide reactant stream to form a mixed reactant stream; heating the mixed reactant stream; producing a reverse-water gas shift product stream in a reverse-water gas shift unit by contacting the mixed reactant stream with a catalyst at a temperature above about 400° C., wherein heating the mixed reactant stream includes exchanging heat between the reverse-water gas shift product stream and the mixed reactant stream; and separating water from the reverse-water gas shift product stream to produce a refined syngas stream; producing a hydrocarbon synthesis product stream using a Fischer-Tropsch unit, wherein the hydrocarbon synthesis product stream includes hydrocarbons.

The method of the preceding paragraph can optionally include, additionally and/or alternatively, any one or more of the following steps, configurations, and/or additional components.

For example, the method may further include separating carbon dioxide from the refined syngas stream to form a purified syngas stream and a carbon dioxide product stream.

For example, the method may further include compressing the purified syngas stream sufficient to form a compressed purified syngas stream, and transferring the compressed purified syngas stream to the Fischer-Tropsch unit.

For example, the method may further include compressing the carbon dioxide product stream sufficient to form a compressed carbon dioxide product stream.

For example, the method may further include mixing the compressed carbon dioxide product stream with a carbon dioxide feed stream to form the carbon dioxide reactant stream.

For example, the method may further include compressing the oxygen product stream to form a compressed oxygen product stream, and transferring the compressed oxygen product stream to a downstream process unit that does not perform any of: electrolysis, a reverse-water gas shift reaction, and a Fischer-Tropsch reaction.

For example, the compressed oxygen product stream may be transferred to at least one of a wax oxidation unit, a tail gas auto-thermal reforming unit, and a tail gas reforming unit.

For example, the mixed reactant stream may be contacted with the catalyst at a pressure ranging from about 20 bar to about 40 bar.

For example, at least a portion of the refined syngas stream may be transferred to the Fischer-Tropsch unit without further compression.

For example, the catalyst in the reverse-water gas shift unit may include a cerium-containing catalyst, and wherein the cerium-containing catalyst has greater than 95% selectivity for carbon monoxide formation in a mixture of carbon dioxide and hydrogen.

For example, heating the mixed reactant stream may be at least partially performed outside of the reverse-water gas shift unit.

1. A catalyst, the catalyst comprising:
catalytically active material including a formula: CeJQO, wherein Ce is Cerium, J includes at least one of Zirconium, Hafnium, Niobium, Tantalum, and Titanium, Q includes at least one of Praseodymium, Terbium, Thulium, Europium, Samarium, Ytterbium, Gallium, Germanium, Indium, Tin, Antimony, and Bismuth, and O is oxygen; and
a support,
wherein the catalyst has greater than 95% selectivity for carbon monoxide formation in a mixture of carbon dioxide and hydrogen operated at a temperature above 400° C.

2. The catalyst according to claim 1, wherein the support includes one or more of alumina and magnesium aluminate.

3. The catalyst according to claim 1, wherein the support includes one or more of aluminosilicate, zirconium oxide, silicon carbide, steatite, magnesium aluminate, cordierite, magnesium oxide, calcium oxide, potassium oxide, sodium oxide, yttrium oxide, aluminum titanate, and strontium titanate.

4. The catalyst according to claim 1, wherein the support includes a porous, alpha-phase alumina support bead and the catalytically active material forms a coating on substantially an entire surface area of the porous, alpha-phase alumina support bead.

5. The catalyst according to claim 1 further comprising magnesium oxide in contact with a surface of the support.

6. The catalyst according to claim 1, wherein the catalyst is coke-resistant and substantially inert to methanation during formation of carbon monoxide in the mixture of carbon dioxide and hydrogen.

7. The catalyst according to claim 1, wherein J includes at least one of Zirconium, Hafnium, and Niobium.

8. The catalyst according to claim 1, wherein Q includes at least one of Praseodymium, Terbium, and Bismuth.

9. The catalyst according to claim 1, wherein J includes Zirconium.

10. The catalyst according to claim 1, wherein Q includes Praseodymium.

11. A catalyst, the catalyst comprising:
catalytically-active material including a formula: CeₓJ_{y}Q_{z}O₂₋ₙ, wherein Ce is Cerium, J includes at least one of Zirconium, Hafnium, Niobium, Tantalum, and Titanium, Q includes at least one of one or more metals and one or more metalloids, and O is oxygen; and wherein x, y, and z represent component mole fractions with respect to total moles of Ce, J, and Q; and wherein x ranges from 0.4 to 0.999, y ranges from 0.001 to 0.60, z ranges from 0.001 to 0.2, and n ranges from 0 to 0.5; and
a support.

12. The catalyst according to claim 11, wherein J includes at least one of Zirconium, Hafnium, and Niobium.

13. The catalyst according to claim 11, wherein J includes Zirconium.

14. The catalyst according to claim 11, wherein the one or more metals are selected from Praseodymium, Terbium, Thulium, Europium, Samarium, Ytterbium, Gallium, Indium, Tin, and Bismuth.

15-17. (canceled)

18. The catalyst according to claim 11, wherein J includes Zirconium, Q includes Praseodymium; and wherein x ranges from 0.9 to 0.999, y ranges from 0.001 to 0.1, and z ranges from 0.001 to 0.05.

19-22. (canceled)

23. The catalyst according to claim 11, wherein the support includes one or more of alumina and magnesium aluminate.

24-26. (canceled)

27. A method for performing a reverse-water gas shift reaction, the method comprising:
contacting a feed stock with a catalyst at a temperature above 400° C., sufficient to generate a reaction product,
wherein the feed stock includes carbon dioxide and hydrogen, the reaction product includes carbon monoxide and water, and the catalyst includes (1) catalytically active material including a formula: CeJQO, wherein Ce is Cerium, J includes at least one of Zirconium, Hafnium, Niobium, Tantalum, and Titanium, Q includes at least one of Praseodymium, Terbium, Thulium, Europium, Samarium, Ytterbium, Gallium, Germanium, Indium, Tin, Antimony, and Bismuth, and O is oxygen, and (2) a support.

28. The method according to claim 27, wherein the support includes one or more of alumina and magnesium aluminate.

29. (canceled)

30. The method according to claim 27, wherein the catalyst includes magnesium oxide in contact with a surface of the support.

31-38. (canceled)

39. The catalyst method according to claim 27, wherein J includes Zirconium and Q includes Praseodymium.

40-59. (canceled)
